(19) United States
(12) Patent Application Publication
(10) Pub. No.: US 2025/0133467 A1
(43) Pub. Date: Apr. 24, 2025

(54) MANAGING CONFIGURATIONS FOR CONDITIONAL SECONDARY NODE ADDITION AND CHANGE

(71) Applicant: GOOGLE LLC, Mountain View, CA (US)

(72) Inventors: Chih-Hsiang Wu, Taoyuan City (TW); Jing-Rong Hsieh, Taipei City (TW)

(21) Appl. No.: 18/681,512

(22) PCT Filed: Aug. 4, 2022
(86) PCT No.: PCT/US2022/039405

§ 371 Date: Feb. 5, 2024

Related U.S. Application Data
(60) Provisional application No. 63/203,992, filed on Aug. 5, 2021.
(60) Provisional application No. 63/314,215, filed on Feb. 25, 2022.

(51) Int. Cl. H04W 36/36; H04W 36/00; H04W 76/20

(52) U.S. Cl. CPC H04W 36/362; H04W 36/0069; H04W 76/20

(57) ABSTRACT

A master node (MN) can implement a method for managing a conditional procedure that involves a user equipment (UE), a candidate secondary node (C-SN), and the MN. The method may include transmitting, to the C-SN, a request to perform the conditional procedure related to the C-SN and the UE, the conditional procedure associated with a condition and a conditional configuration according to which the UE connects to the C-SN when the condition is satisfied; receiving, from the C-SN, a response to the request, the response including an SN-to-MN container; and retrieving the conditional configuration from the SN-to-MN container.

### FIELD OF THE DISCLOSURE

This disclosure relates generally to wireless communications and, more particularly, to managing conditional procedures for multi-connectivity such as conditional secondary node addition or change procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) sometimes can concurrently utilize resources of multiple radio access network (RAN) nodes, such as base stations or components of a distributed base station, interconnected by a backhaul. Concurrently using two base stations is known as dual connectivity (DC) and is standardized for LTE (i.e., “Long Term Evolution” wireless mobile network) communication systems. In 5G (standardized 5th generation wireless network) communication systems, multi-connectivity (MC) refers to the concurrent use of multiple independent communication paths, nodes, access points or base stations for data transmission to a UE. For the sake of simplicity, in this document, the term “dual connectivity” encompasses “multi-connectivity” as well. The network nodes serving the same UE may all be nodes using the same radio access technology (RAT) or may include nodes using different RATs. Example DC configurations include NR-only dual connectivity (NR-DC) and EUTRA and NR dual connectivity (EN-DC). When a UE operates in DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, a UE utilizes resources of one network node at a time, in single connectivity (SC).

Third Generation Partnership Project (3GPP) specification TS 37.340 v16.6.0 describes procedures for a UE to add or change an SN in DC scenarios. These procedures involve messaging (e.g., RRC signaling and preparation) between RAN nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN or PSCell addition/change, “conditional” procedures have been considered (i.e., conditional SN or PSCell addition/change). Unlike the “immediate” procedures discussed above, these conditional procedures do not add or change the SN or PSCell until the UE determines that a condition is satisfied. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.).

To configure a conditional procedure, the RAN provides the condition to the UE, along with a configuration (e.g., one or more random-access preambles, etc.) that will enable the UE to communicate with the appropriate (target) base station, or via the appropriate (target) cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated to the PSCell and derived from one or more security configuration parameters in the RRC reconfiguration message. The SN also derives security key(s) that match the security key(s) derived from the UE. After the UE successfully connects to the PSCell, the RAN (e.g., the SN) communicates data with the UE by using the matching security key(s) and the multiple configuration parameters.

In some cases, a candidate SN (C-SN) can provide multiple candidate configurations when, for example, multiple candidate PSCells are available. When the MN completes the configuration for conditional SN-related procedure (e.g., conditional SN addition or conditional SN cell change), the MN at this time cannot determine which candidate secondary cell the UE will connect to in the future. Moreover, because the UE connects to the secondary cell only subject to the fulfillment of one or more conditions, the MN cannot determine whether the UE will even connect to any of the candidate cells in the future.

Recently, 3GPP has discussed methods for distributing conditional configurations of candidate PSCells from the C-SN to the MN. However, how existing information elements for immediate SN-related procedures should be used (or not used) to exchange information during conditional SN-related procedures remains an open question. For example, in some 3GPP proposals, the C-SN transmits a list of conditional configurations to the MN in an SN Addition Request Acknowledge message. In such cases, it is not clear how the existing, mandatory SN-to-MN container used to transmit a configuration from an SN to an MN in an SN Addition Request Acknowledge message for an immediate SN-related procedure should be handled by the C-SN and MN.

### SUMMARY

To overcome the above-identified problems, a network node operating as a C-SN or an MN can implement the methods described below to distribute conditional configurations during SN-related procedures. To prepare for an SN-related procedure, an MN generally transmits a request to an SN (e.g., an SN Addition Request message). The SN then transmits a configuration for the SN (or one or more conditional configurations if the SN is a C-SN) to the MN in an acknowledgement (e.g., an SN Addition Request Acknowledge message). For immediate SN-related procedures, conventionally the SN includes the configuration in an SN-to-MN container (e.g., an S-NG-RAN node to M-NG-RAN node Container IE, or an SgNB to MeNB Container IE) in the acknowledgement.

In some embodiments, during preparation for a conditional SN-related procedure, a C-SN includes the SN-to-MN container in the acknowledgement. In such embodiments, the MN may ignore the SN-to-MN container. Instead of retrieving conditional configurations from the SN-to-MN container, the MN retrieves the conditional configurations, from a second container that the C-SN includes in the acknowledgement (e.g., an RRC container in a Conditional PSCell Addition Information Acknowledge IE). Alternatively, the MN may retrieve one conditional configuration from the SN-to-MN container, and retrieve the remaining conditional configurations from the second container, if included in the acknowledgement.

In other embodiments, the C-SN excludes the SN-to-MN container from the acknowledgement. The MN, responsive to determining that the acknowledgement is for a conditional SN-related procedure, does not generate an error message. This is different from a scenario involving an immediate SN-related procedure, in which the MN would conventionally transmit an error message to the SN in response to receiving an acknowledgement lacking an SN-to-MN container.

One example embodiment is a method in a master node (MN) for managing a conditional procedure that involves a user equipment (UE), a candidate secondary node (C-SN), and the MN. The method includes: transmitting, to the C-SN, a request to perform a conditional procedure related to the C-SN and the UE, the conditional procedure associated with a condition and a conditional configuration according to which the UE connects to the C-SN when the condition is satisfied; receiving, from the C-SN, a response to the request, the response including an SN-to-MN container; and retrieving the conditional configuration from the SN-to-MN container.

Another example embodiment is a method in a candidate secondary node (C-SN) for managing a conditional procedure that involves a user equipment (UE), a master node (MN), and the C-SN. The method includes: receiving, from the MN, a request to perform a conditional procedure related to the C-SN and the UE, the conditional procedure associated with a condition and a conditional configuration according to which the UE connects to the C-SN when the condition is satisfied; generating a response to the request, the response including an SN-to-MN container including the conditional configuration; and transmitting, to the MN, the response.

Another example embodiment is a method implemented in a master node (MN) for managing a conditional procedure configuration related to a user equipment (UE) able to communicate in dual connectivity (DC) with the MN and a secondary node (SN). The method includes: transmitting, by the MN to the SN, a request to perform a procedure related to communication between the UE and the SN; receiving, by the MN from the SN, a response to the request, the response including an SN-to-MN container; and determining, by the MN, whether the procedure is a conditional procedure based on a content of the SN-to-MN container.

Yet another example embodiment is a network node including processing hardware and a transceiver, configured to implement one of the methods described above.

### BRIEF DESCRIPTION OF THE DRAWINGS

FIG. 1A is a block diagram of an example system in which a base station and/or a user equipment (UE) cane manage conditional procedures related to a master node (MN) or a secondary node (SN) according to various embodiments;

FIG. 1B is another block diagram of an example system in which a radio access network (RAN) and a user device can manage conditional procedures related to an MN or an SN according to various embodiments;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-1B can communicate with base stations;

FIG. 3A illustrates an example scenario in which an MN receives coordination information from the SN during an SN addition request procedure, and refrains from applying the coordination information or restriction information until determining that the UE has connected to a particular cell of the SN;

FIG. 3B illustrates an example scenario in which an MN performs an SN addition request procedure with an SN, but receives coordination information from the C-SN after the UE has connected to a particular cell of the SN;

FIG. 3C illustrates an example scenario in which an SN provides, to the MN, the same coordination information for all candidate cells during an SN addition request procedure, and the MN applies the coordination information immediately;

FIG. 3D illustrates a scenario in which an MN initiates a conditional SN change procedure, and applies coordination information according as in FIGS. 3A-C;

FIG. 3E illustrates a scenario in which an SN initiates a conditional SN change procedure, and the MN applies coordination information as in FIGS. 3A-C;

FIG. 4A is a flow diagram of an example method for delayed application of coordination information received during a conditional SN configuration procedure, until after determining to which secondary cell the UE is connected, where the method can be implemented in a base station of FIG. 1A operating as an MN;

FIG. 4B is a flow diagram of an example method for receiving and applying coordination information after determining to which secondary cell the UE is connected, where the method can be implemented in a base station of FIG. 1A operating as an MN;

FIG. 5 is a flow diagram of an example method for determining whether to retrieve or to ignore an RRC message in an SN-to MN container received during an SN addition procedure depending on whether the SN addition procedure is conditional, where the method can be implemented in a base station of FIG. 1A operating as an MN;

FIG. 6A is a flow diagram of an example method for determining whether to include an RRC message in an SN-to-MN container in an SN Request Acknowledge message during an SN addition procedure depending on whether the SN addition procedure is conditional, where the method can be implemented in a base station of FIG. 1A operating as an SN or candidate SN;

FIG. 6B is a flow diagram of an example method similar to that of FIG. 6A, but with the base station refraining from including the SN-to-MN container in the SN Request Acknowledge message if the SN addition procedure is conditional, where the method can be implemented in a base station of FIG. 1A operating as an SN or candidate SN;

FIG. 7 is a flow diagram of an example method for initiating a conditional SN-related procedure and determining that an SN Request Acknowledge excluding a mandatory SN-to-MN Container is valid, where the method can be implemented in a base station of FIG. 1A operating as an MN;

FIG. 8 is a flow diagram of an example method for determining whether a received SN Request Acknowledge message excluding a mandatory SN-to-MN Container is valid depending on whether an SN-related procedure is conditional, where the method can be implemented in a base station of FIG. 1A operating as an MN;

FIG. 9 is a flow diagram of an example method for generating and including C-SN configurations in an SN-to-MN container or a different container during a conditional SN-related procedure, which can be implemented in a base station of FIG. 1A operating as an SN or candidate SN;

FIG. 10 is a flow diagram of an example method for retrieving one or more C-SN configurations from an SN-to-MN container or a different container during a conditional SN-related procedure, where the method can be implemented in a base station of FIG. 1A operating as an MN;

FIG. 11 is a flow diagram of an example method for generating (i) an RRC container including an RRC message or (ii) a conditional configuration including an RRC message retrieved from the SN-to-MN container, depending on whether an SN-related procedure is conditional, where the method can be implemented in a base station of FIG. 1A operating as an MN;

FIG. 12 is a flow diagram of an example method for managing an SN-related procedure, where the method can be implemented in a base station of FIG. 1A operating as an MN; and

FIG. 13 is a flow diagram of an example method for managing an SN-related procedure, where the method can be implemented in a base station of FIG. 1A operating as a C-SN.

### DETAILED DESCRIPTION OF THE DRAWINGS

As discussed in detail below, a UE and/or one or more base stations manage conditional procedures, such as conditional PSCell addition or change (CPAC). This disclosure may also refer to a conditional PSCell addition procedure and a conditional PSCell change procedure separately using the acronyms CPA and CPC, respectively.

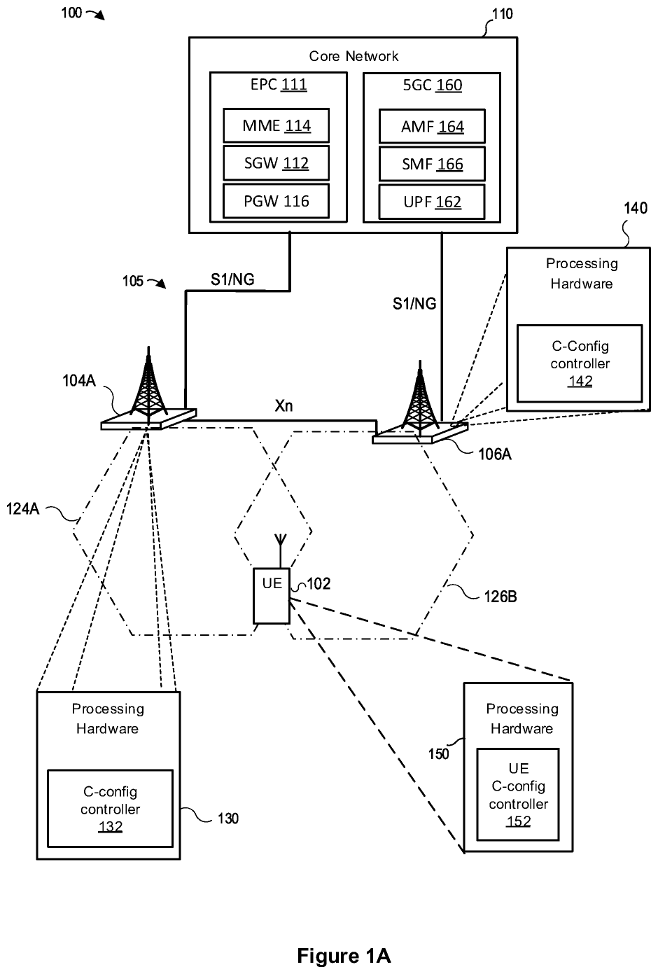

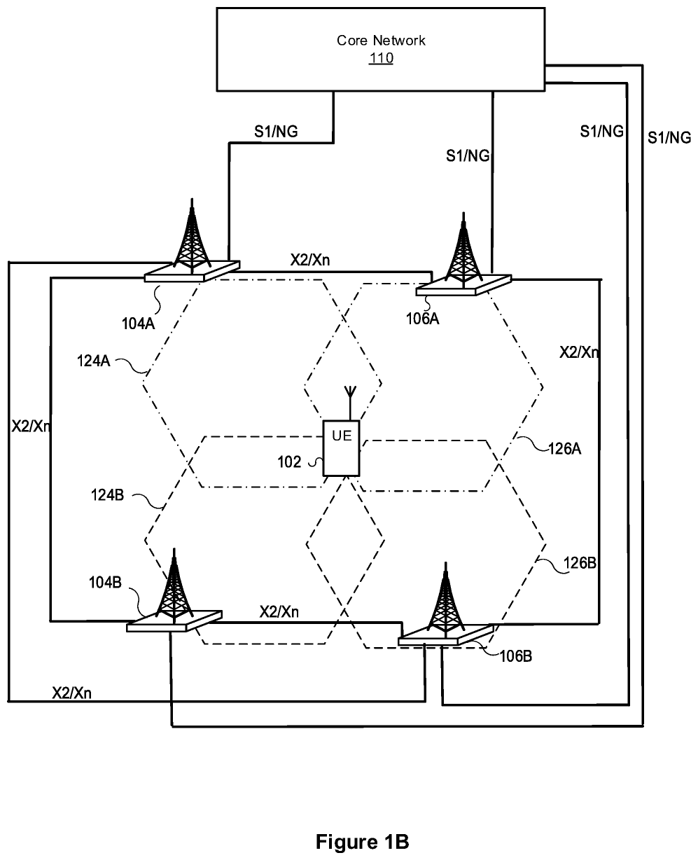

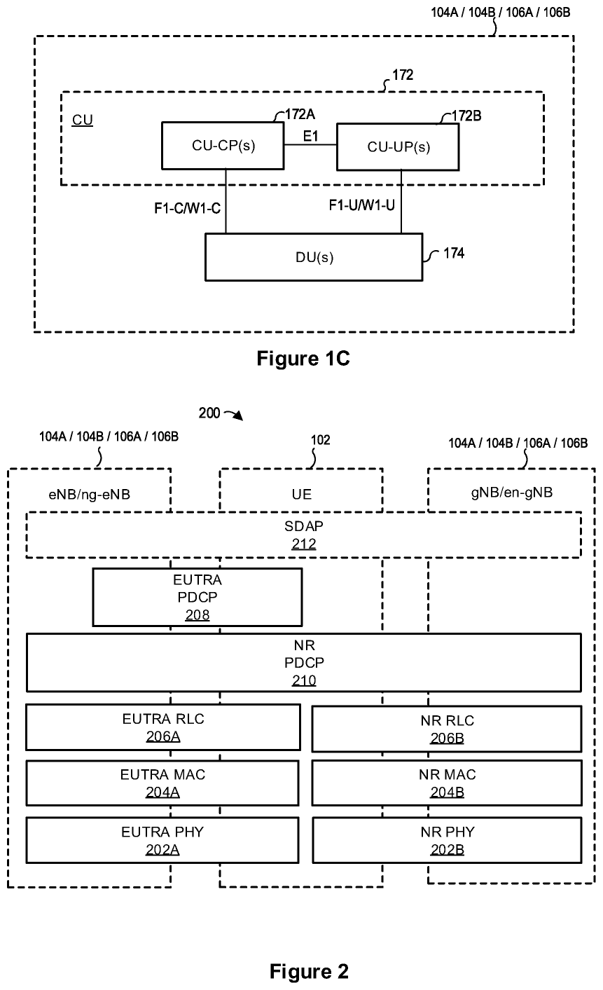

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN. The base station 104A also includes hardware for wirelessly communicating with other devices, including the UE 102, such as an antenna, transceiver, emitter, and/or receiver.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN. The base station 106A also includes hardware for wirelessly communicating with other devices, including the UE 102, such as an antenna, transceiver, emitter, and/or receiver.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures. The UE 102 also includes hardware for wirelessly communicating with other devices, including the RAN 105, such as an antenna, transceiver, emitter, and/or receiver.

More particularly, the conditional configuration controllers 132, 142, and 152 can perform at least some of the methods discussed below with reference to the messaging and flow diagrams. Although FIG. 1A illustrates the conditional configuration controllers 132 and 142 as separate components, in at least some of the scenarios the base stations 104A and 106A can have similar structure and in different scenarios operate as MN or SN nodes. In other words, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the methods discussed below also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A.

In some scenarios, the base station 104A performs an immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR.

In one scenario, the MN 104A performs an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A performs an immediate PSCell change to change the PSCell of the UE 102 to the cell 126A. In one implementation, the SN 106A transmits a configuration changing the PSCell to cell 126A to the UE 102 via a signaling radio bearer (SRB) (e.g., SRB3) for the immediate PSCell change. In another implementation, the SN 106A transmits a configuration changing the PSCell to the cell 126A to the UE 102 via the MN 104A for the immediate PSCell change. The MN 104A may transmit the configuration immediately changing the PSCell to the cell 126A to the UE 102 via SRB1.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A determines whether the condition associated with the conditional SN Addition procedure is satisfied in response to a request received from the base station 106A or in response to one or more measurement results received from the UE 102 or obtained by the MN 104A from measurements on signals received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 disconnects from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results, which may be received from the UE 102 via the SRB or via the MN 104A or may be obtained by the SN 106A from measurements on signals received from the UE 102. In some embodiments, the SN 106A transmits the configuration for the C-PSCell 126A via the MN 104A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A may not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B. The condition is satisfied if the signal strength/quality exceeds a certain threshold or otherwise corresponds to an acceptable measurement. For example, when the one or more measurement results the UE 102 obtains on the C-PSCell 126A are above a threshold configured by the MN 104A or the SN 106A or above a pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can operate as a master eNB (MeNB) or a master gNB (MgNB), and the base station 106A or 106B can operate as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is a MeNB and the base station 106A is a C-SgNB for the UE 102, the UE 102 can be in SC with the MeNB. In this scenario, the MeNB 104A might or might not configure the base station 106B as another C-SgNB to the UE 102.

In some cases, an MeNB, an SeNB or a C-SgNB is implemented as an ng-eNB rather than an eNB. When the base station 104A is a Master ng-eNB (Mng-eNB) and the base station 106A is an SgNB, the UE 102 can be in next generation (NG) EUTRA-NR DC (NGEN-DC) with the Mng-eNB and the SgNB. In this scenario, the Mng-eNB 104A might or might not configure the base station 106B as a C-SgNB to the UE 102, and the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A might or might not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MgNB 104A might or might not configure the base station 106B as a C-SgNB to the UE 102, and, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A might or might not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A might or might not configure the base station 106B as a C-Sng-eNB to the UE 102. and the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A might or might not configure the base station 106B as another C-Sng-eNB to the UE 102.

The base stations 104A, 106A, and 106B can connect to the same core network (CN) 110, which can be an evolved packet core (EPC) 111 or a fifth-generation core (5GC) 160. The base station 104A can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-eNB, or an MgNB, and the base station 106A operates as an SgNB or an Sng-eNB. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-eNB or an MgNB, the base station 106A operates as an SgNB or an Sng-eNB, and the base station 106B operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the methods discussed below also can apply to other suitable radio access and/or core network technologies such as sixth generation (6G) radio access and/or 6G core network or 5G NR-6G DC.

FIG. 1C depicts an example of a distributed implementation of a base station such as the base station 104A, 104B, 106A, or 106B. The base station in this distributed implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 106A operates as an SN or a candidate SN (C-SN). The base station 106B can have hardware same as or similar to the base station 106A. In some embodiments, the CU 172 can include a logical node CU-CP 172A that hosts the control plane part of the Packet Data Convergence Protocol (PDCP) protocol of the CU 172. The CU 172 can also include logical node(s) CU-UP 172B that hosts the user plane part of the PDCP protocol and/or Service Data Adaptation Protocol (SDAP) protocol of the CU 172.

The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as an MN, an SN, or a C-SN. The processing hardware may include further a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or an RRC sublayer (not shown in FIG. 2) to exchange RRC messages or non-access-stratum (NAS) messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUs, Internet Protocol (IP) packets, or Ethernet packets.

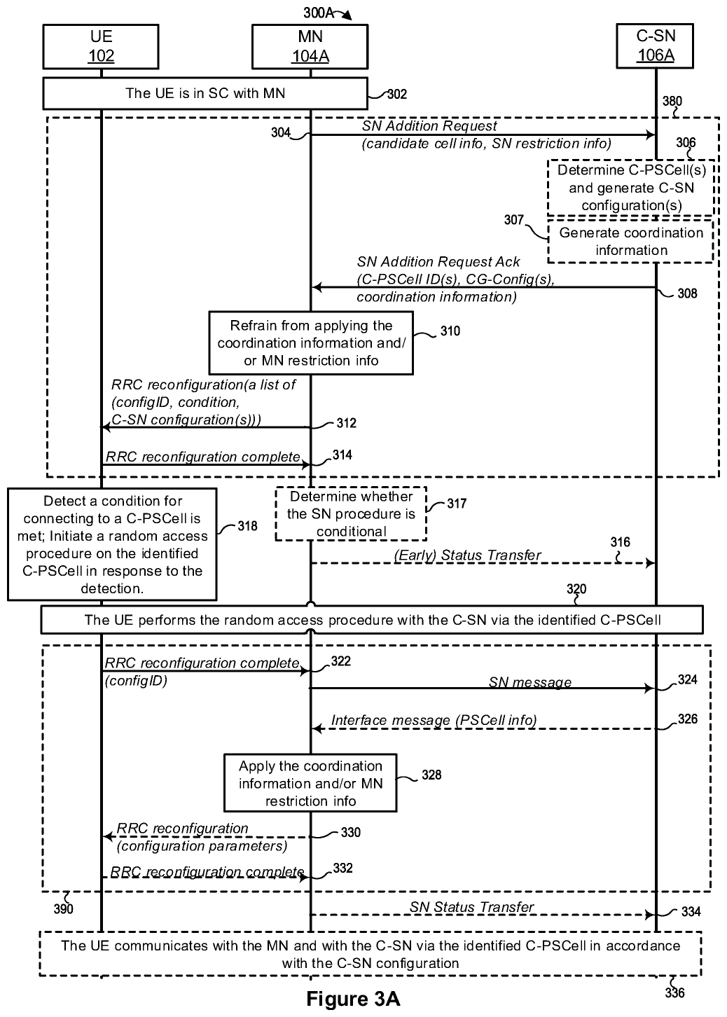

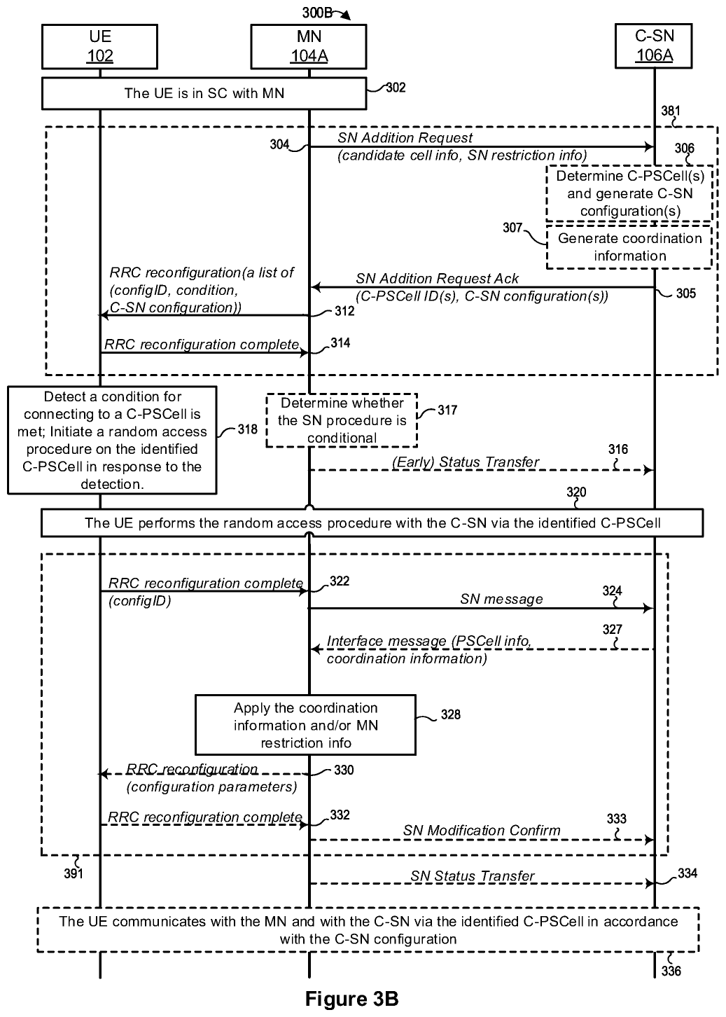

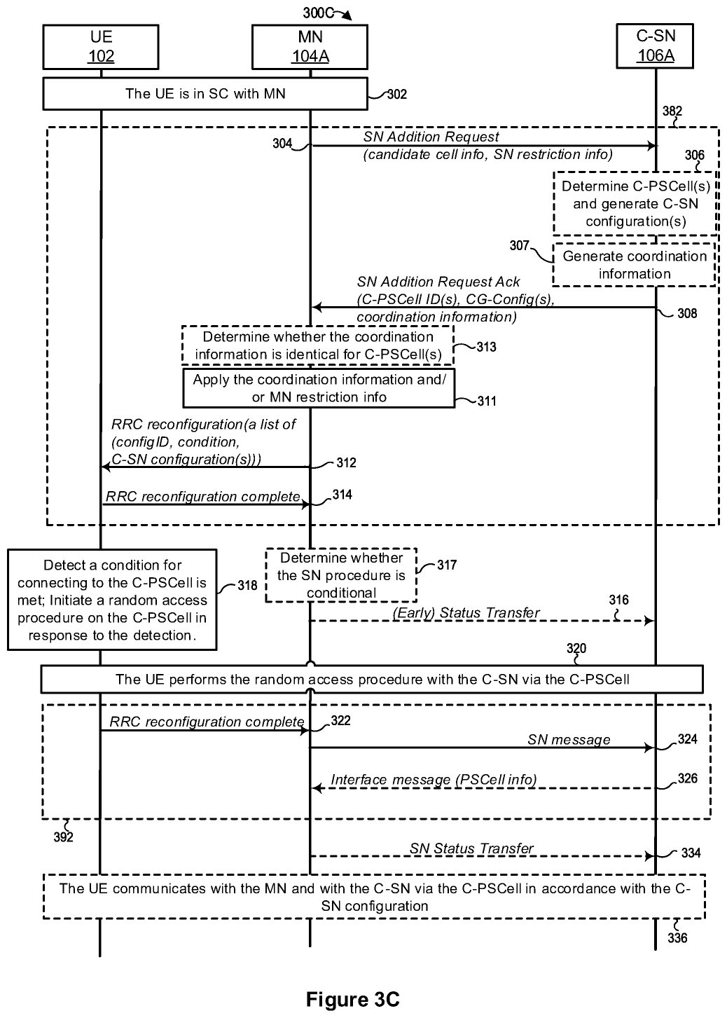

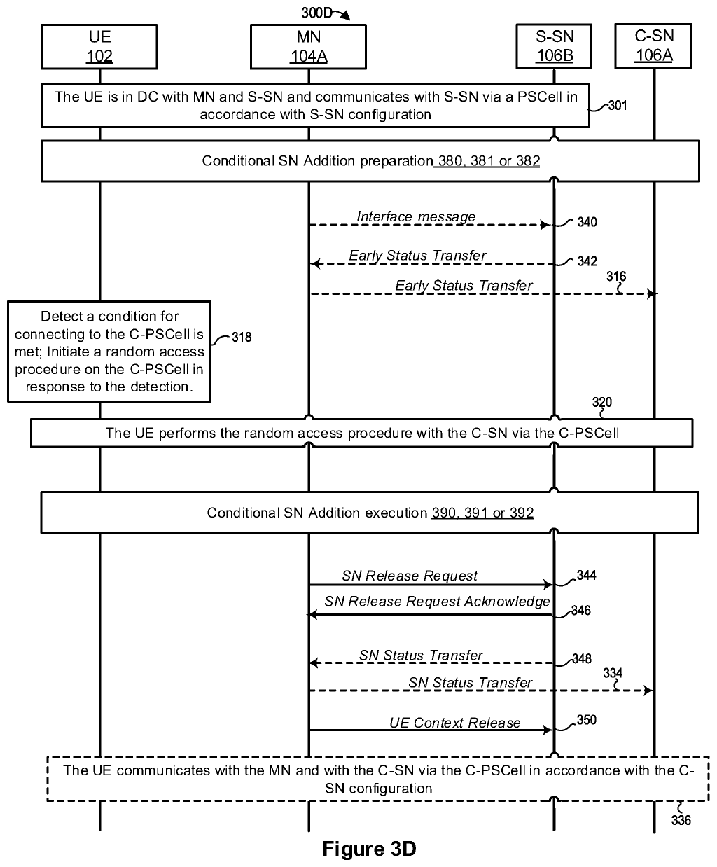

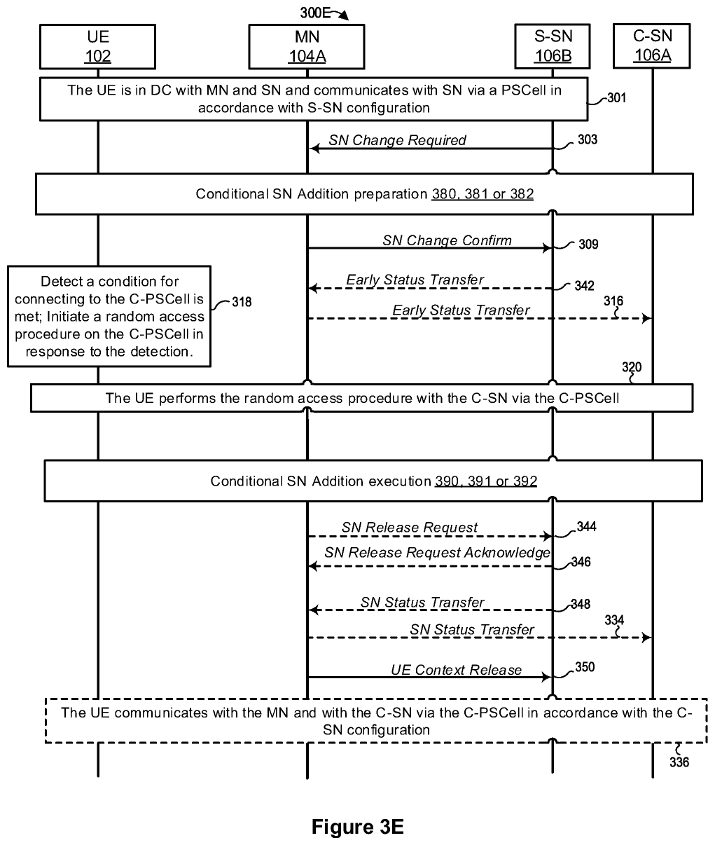

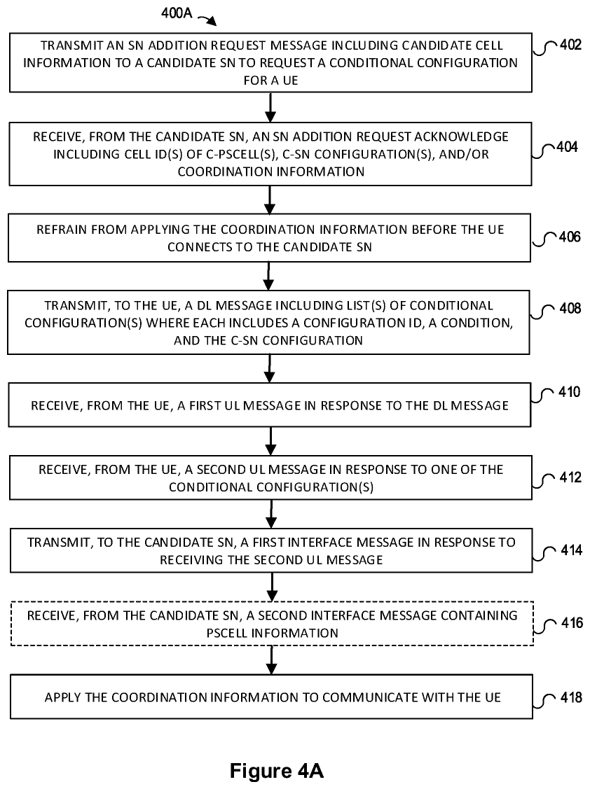

Next, several example scenarios in which a UE and/or a RAN perform methods for supporting conditional procedures are discussed with reference to FIGS. 3A-3E. Generally speaking, similar events in FIGS. 3A-3E are labeled with the same reference numbers, with differences discussed below where appropriate. Time flows from the upper to the lower part in these figures.

Referring first to FIG. 3A, in a scenario 300A, an MN receives coordination information from the SN during an SN addition request procedure, and refrains from applying the coordination information or restriction information until determining that the UE has connected to a particular cell of the SN. In the scenario 300A, the base station 104A operates as an MN, and the base station 106A operates as a C-SN. Initially, the UE 102 operates 302 in single connectivity (SC) with the MN 104A. While in SC, the UE 102 communicates UL PDUs and/or DL PDUs with the MN 104A (e.g., via a PCell 124A) in accordance with an MN configuration.

TABLE 1
Example fields in MN and/or SN restriction information

The MN 104A then determines to configure the base station 106A as a C-SN for conditional
PSCell addition (CPA)based on measurement result(s) from the UE 102, for example. In
some implementations, the MN 104A can detect or estimate that the UE 102 is moving
toward coverage (i.e., one or more cells) of the base station 106A based on uplink signals
received from the UE 102 or positioning measurement result(s) received from the UE 102.
In response to the determination, the MN 104A sends 304 an SN Addition Request message
to the C-SN 106A. The MN 104A can generate candidate cell information including the
measurement result(s) of the one or more cells and include the candidate cell information in
the SN Addition Request message. Furthermore, the MN 104A can determine SN restriction
information to restrict (values of) configuration parameters that the C-SN 106A can
configure for the UE 102. The MN 104A can include the SN restriction information in the
SN Addition Request message. The MN 104A may determine MN restriction information to
restrict (values of) configuration parameters that the MN 104A can configure for the UE 102
when determining the SN restriction information. In some implementations, the MN
restriction information and/or the SN restriction information include at least one of the fields
shown in Table 1 below.powerCoordination-FR1
Indicates the maximum power that the UE can use in FR1.
powerCoordination-FR2
Indicates the maximum power that the UE can use in frequency range 2 (FR2). This field is only used in NR-DC.
nrdc-PC-mode-FR1
Indicates the uplink power sharing mode that the UE uses in NR-DC FR1 (see TS 38.213 [13], clause 7.6).
nrdc-PC-mode-FR2
Indicates the uplink power sharing mode that the UE uses in NR-DC FR2 (see TS 38.213 [13], clause 7.6).
overheatingAssistanceSCG
Contains the UE's preference on reduced configuration for NR SCG to address overheating.
This field is only used in (NG)EN-DC.
p-maxEUTRA
Indicates the maximum total transmit power to be used by the UE in the E-UTRA cell group
(see TS 36.104 [33]). This field is used in (NG)EN-DC and NE-DC.
p-maxNR-FR1
Indicates the maximum total transmit power to be used by the UE in the NR cell group across all serving cells in frequency
range 1 (FR1) (see TS 38.104 [12]). The field is used in (NG)EN-DC and NE-DC.
p-maxUE-FR1
Indicates the maximum total transmit power to be used by the UE across all serving cells in frequency range 1 (FR1).
p-maxNR-FR1-MCG
Indicates the maximum total transmit power to be used by the UE in the NR cell group across all serving cells in frequency
range 1 (FR1) (see TS 38.104 [12]) the UE can use in NR MCG. This field is only used in NR-DC.
p-maxNR-FR2-SCG
Indicates the maximum total transmit power to be used by the UE in the NR cell group across all serving cells in frequency
range 2 (FR2) (see TS 38.104 [12]) the UE can use in NR SCG.
p-maxUE-FR2
Indicates the maximum total transmit power to be used by the UE across all serving cells in frequency range 2 (FR2).
p-maxNR-FR2-MCG
Indicates the maximum total transmit power to be used by the UE in the NR cell group across all serving cells in frequency
range 2 (FR2) (see TS 38.104 [12]) the UE can use in NR MCG.
pdcch-BlindDetectionSCG
Indicates the maximum value of the reference number of cells for PDCCH blind detection allowed to be configured for the
SCG.
configRestrictInfo
Includes fields for which SgNB is explicitly indicated to observe a configuration restriction.
drx-ConfigMCG
This field contains the complete DRX configuration of the MCG. This field is only used in NR-DC.
drx-InfoMCG
This field contains the DRX long and short cycle configuration of the MCG. This field is used in (NG)EN-DC and NE-DC.
drx-InfoMCG2
This field contains the drx-onDurationTimer configuration of the MCG. This field is only used in (NG)EN-DC.
fr-InfoListMCG
Contains information of FR information of serving cells that include PCell and SCell(s) configured in MCG.
maxToffset
Indicates the maximum Toffset value the SN is allowed to use for scheduling SCG transmissions (see TS 38.213 [13]). This
field is used in NR-DC only when the fields nrdc-PC-mode-FR1-r16 or nrdc-PC-mode-FR2-r16 are set to dynamic. Value
ms0dot5 corresponds to 0.5 ms, value ms0dot75 corresponds to 0.75 ms, value ms1 corresponds to 1 ms and so on.

In some implementations, the MN 104A can determine the MN restriction information and the SN restriction information in accordance with capabilities of the UE 102. More specifically, the MN 104 determines the MN restriction information and the SN restriction information such that when the UE 102 simultaneously communicates with the MN 104 and C-SN 106A, the communication with the MN 104 and C-SN 106A does not exceed a capability of the UE 102. For example, the MN 104 can determine a maximum uplink power, that MN 104 allows the UE 102 to transmit in communication with the MN 104, in the MN restriction info, and the MN 104 can determine a maximum uplink power, that C-SN 106A allows the UE 102 to transmit in communication with the C-SN 106A, in the SN restriction information.

In response to receiving 304 the SN Addition Request message, the C-SN 106A determines 306 one or more C-PSCells (C-PSCell(s)) and generates one or more C-SN configurations (C-SN configuration(s)), each C-SN configuration associated with a particular C-PSCell in the C-PSCell(s), for the UE 102. For example, the C-PSCells may be the cell 126A and the cell 126C. In some implementations, the C-SN 106A determines the C-PSCell(s) and the C-SN configuration(s) taking into account the candidate cell information and the SN restriction information. The C-SN 106A transmits 308 an SN Addition Request Acknowledge message including ID(s) of the C-PSCell(s) and the C-SN configuration(s) to the MN 104A. The SN Addition Request Acknowledge message might or might not include an SN-to-MN Container. In some implementations, the SN-to-MN container is an S-NG-RAN node to M-NG-RAN node Container IE, which has been defined in the 3GPP 38.423 Release 15 specification. In other implementations, the SN-to-MN container is an SgNB to MeNB Container IE, which has been defined since the 3GPP 36.423 Release 15 specification.

TABLE 2
Example Coordination Parameters

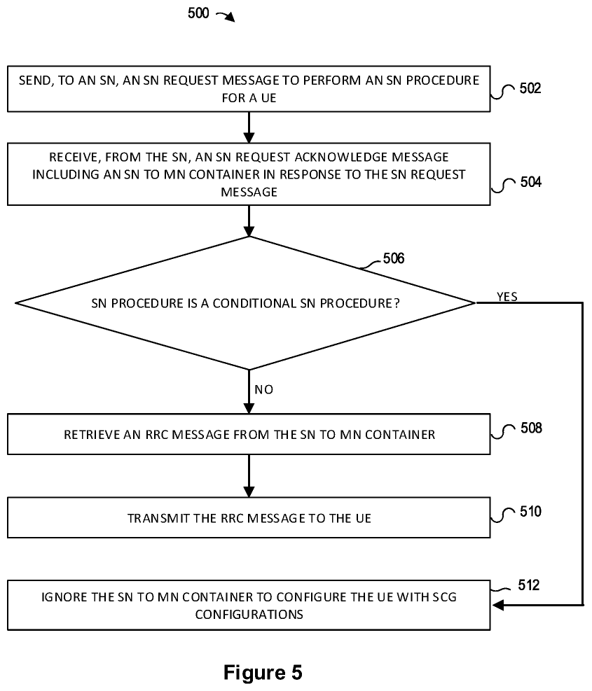

FIGS. 5-11, described below, illustrate methods that a C-SN can utilize to determine whether to
include an SN-to-MN container in the SN Addition Request Acknowledge message, and methods
that an MN can utilize to determine how to handle receiving an SN Addition Request
Acknowledge message that includes or not an SN-to-MN container. In some implementations, for
each of the C-SN configuration(s), the C-SN 106A generates a CG-Config IE including the C-SN
configuration and includes the CG-Config(s) in the SN Addition Request Acknowledge message.
In further implementations, the C-SN 106A can generate 307 coordination information and
include the coordination information in the SN Addition Request Acknowledge message. In some
implementations, the coordination information includes one or more coordination parameters. In
some implementations, the C-SN 106A can include the one or more coordination parameters in
the CG-Config(s) and/or the SN Addition Request Acknowledge message. For example, the
coordination information can include coordination parameters such as a Resource Coordination
Info IE (e.g., SgNB Resource Coordination Information IE or MR-DC Resource Coordination
Information IE) associated to a particular C-PSCell, one or more power coordination parameters
(e.g., powerCoordination-FR1 and/or powerCoordination-FR2), a discontinuous reception (DRX)
configuration (e.g., DRX-Info or DRX-Info2). The coordination information can include
coordination information for each of the C-PSCell(s). As another example, the coordination
parameters can include one or more coordination parameters as shown in Table 2
below.configRestrictModReq
Used by SN to request changes to SCG configuration restrictions previously set by MN to ensure UE capabilities are respected.
E.g. can be used to request configuring an NR band combination whose use MN has previously forbidden. SN only includes this
field in SN-initiated procedures.
drx-ConfigSCG
This field contains the complete DRX configuration of the SCG. This field is only used in NR-DC.
drx-InfoSCG
This field contains the DRX long and short cycle configuration of the SCG. This field is used in (NG)EN-DC and NE-DC.
drx-InfoSCG2
This field contains the drx-onDurationTimer configuration of the SCG. This field is only used in (NG)EN-DC.
fr-InfoListSCG
Contains information of FR information of serving cells that include PScell and SCells configured in SCG.
measuredFrequenciesSN
Used by SN to indicate a list of frequencies measured by the UE.
needForGaps
In NE-DC, indicates wheter the SN requests gNB to configure measurements gaps.
ph-InfoSCG
Power headroom information in SCG that is needed in the reception of PHR MAC CE of MCG
ph-SupplementaryUplink
Power headroom information for supplementary uplink. In the case of (NG)EN-DC and NR-DC, this field is only present when
two UL carriers are configued for a serving cell and one UL carrier reports type1 PH while the other reports type 3 PH.
ph-Type1or3
Type of power headroom for a certain serving cell in SCG (PSCell and activated SCells). Value type1 refers to type 1 power
headroom, value type3 refers to type 3 power headroom. (See TS 38.321 [3]).
ph-Uplink
Power headroom information for uplink.
pSCellFrequency, pSCellFrequencyEUTRA
Indicates the frequency of PSCell in NR (i.e., pSCellFrequency) or E-UTRA (i.e., pSCellFrequencyEUTRA). In this version of the
specification, pSCellFrequency is not used in NE-DC whereas pSCellFrequencyEUTRA is only used in NE-DC. pSCellFrequency
indicates the absoluteFrequencySSB.
reportCGI-RequestNR, reportCGI-RequestEUTRA
Used by SN to indicate to MN about configuring reportCGI procedure. The request may optionally contain information about the
cell for which SN intends to configure reportCGI procedure. In this version of the specification, the reportCGI-RequestNR is used
in (NG)EN-DC and NR-DC whereas reportCGI-RequestEUTRA is used only for NE-DC.
requestedBC-MRDC
Used to request configuring a band combination and corresponding feature sets which are forbidden to use by MN (i.e. outside of
the allowedBC-ListMRDC) to allow re-negotiation of the UE capabilities for SCG configuration.
requestedMaxInterFreqMeasIdSCG
Used to request the maximum number of allowed measurement identities to configure for inter-frequency measurement. This field
is only used in NR-DC.
requestedMaxIntraFreqMeasIdSCG
Used to request the maximum number of allowed measurement identities to configure for intra-frequency measurement on each
serving frequency.
requestedPDCCH-BlindDetectionSCG
Requested value of the reference number of cells for PDCCH blind detection allowed to be configured for the SCG.
requestedP-MaxEUTRA
Requested value for the maximum power for the serving cells the UE can use in E-UTRA SCG. This field is only used in NE-DC.
requestedP-MaxFR1
Requested value for the maximum power for the serving cells on frequency range 1 (FR1) in this secondary cell group (see TS
38.104 [12]) the UE can use in NR SCG.
requestedP-MaxFR2
Requested value for the maximum power for the serving cells on frequency range 2 (FR2) in this secondary cell group the UE can
use in NR SCG. This field is only used in NR-DC.
selectedBandCombination
Indicates the band combination selected by SN in (NG)EN-DC, NE-DC, and NR-DC. The SN should inform the MN with this
field whenever the band combination and/or feature set it selected for the SCG changes (i.e. even if the new selection concerns a
band combination and/or feature set that is allowed by the allowedBC-ListMRDC)
selectedToffset
Indicates the value used by the SN for scheduling SCG transmissions (i.e. T_{proc, SCG}^{max}, see TS 38.213 [13]).
This field is used in NR-DC only when the fields nrdc-PC-mode-FR1-r16 or nrdc-PC-mode-FR2-r16 are set to dynamic.
The SN can only indicate a value that is less than or equal to maxToffset received from MN.
This field is used in NR-DC only when MN has included the field maxToffset in CG-ConfigInfo.
Value ms0dot5 corresponds to 0.5 ms, value ms0dot75 corresponds to 0.75 ms, value ms1
corresponds to 1 ms and so on.
servCellInfoListSCG-EUTRA
Indicates the carrier frequency and the transmission bandwidth of the serving cell(s) in the SCG in intra-band NE-DC. The field is
needed when MN and SN operate serving cells in the same band for either contiguous or non-contiguous intra-band band
combination or LTE NR inter-band band combinations where the frequency range of the E-UTRA band is a subset of the
frequency range of the NR band (as specified in Table 5.5B.4.1-1 of TS 38.101-3 [34]) in NE-DC.
servCellInfoListSCG-NR
Indicates the frequency band indicator, carrier center frequency, UE specific channel bandwidth and SCS of the serving cell(s) in
the SCG in intra-band (NG)EN-DC. The field is needed when MN and SN operate serving cells in the same band for either
contiguous or non-contiguous intra-band band combination or LTE NR inter-band band combinations where the frequency range
of the E-UTRA band is a subset of the frequency range of the NR band (as specified in Table 5.5B.4.1-1 of TS 38.101-3 [34]) in
(NG)EN-DC.
transmissionBandwidth-EUTRA
Indicates the transmission bandwidth on an E-UTRA carrier frequency as defined by the parameter Transmission Bandwidth
Configuration “NRB” TS 36.104 [33]. The values rb6, rb15, rb25, rb50, rb75, rb100
indicate 6, 15, 25, 50, 75 and 100 resource blocks respectively.
ueAssistanceInformationSCG
Includes for each UE assistance feature associated with the SCG, the information last reported by the UE in the NR
UEAssistanceInformation message for the SCG, if any.

After receiving 308 the SN Addition Request Acknowledge message, the MN 104A refrains 310 from applying the coordination information and/or the MN restriction information. That is, the MN 104A does not take into account the coordination information and/or the MN restriction information when the MN 104A performs communication with the UE 102.

The MN 104A may include the C-SN configuration(s) in an RRC reconfiguration message (e.g., RRCConnectionReconfiguration message or RRCReconfiguration message), and transmits 312 the RRC reconfiguration message to the UE 102. In response, the UE 102 transmits 314 an RRC reconfiguration complete message (e.g., RRCConnectionReconfigurationComplete message or RRCReconfigurationComplete message) to the MN 104A. In some implementations, the MN 104A can assign a particular configuration ID for each of the C-SN configuration(s). For example, in cases where the C-SN configuration(s) include the C-SN configurations 1, . . . , N (N is an integer larger than zero), the MN 104A can assign configuration ID 1, . . . , ID N for the C-SN configurations 1, . . . . N, respectively. In such cases, the MN 104A can include the configuration ID 1, . . . , ID N in the RRC reconfiguration message. In such implementations, the MN 104A can include, in the RRC reconfiguration, trigger condition configurations 1, . . . , N for the C-SN configurations 1, . . . , N, respectively. The MN 104A can generate the trigger condition configurations or receive the trigger condition configurations from the C-SN 106A. Each of the trigger condition configurations can configure one or more conditions, which triggers the UE 102 to connect to the C-SN 106A via a particular C-PSCell configured in a particular C-SN configuration. In such cases, the MN 104A can include the condition configuration identifiers CID 1, . . . , CID N in the RRC reconfiguration message. In some implementations, the MN 104A can generate conditional (re) configuration fields/IEs 1, . . . , N, including the C-SN configurations 1, . . . , N and the trigger condition configurations 1, . . . , N, respectively, and transmits 312 the RRC reconfiguration message including the conditional configuration fields/IEs to the UE 102. In other implementations, the MN 104A can generate RRC container messages (e.g., e.g., RRCConnectionReconfiguration messages or RRCReconfiguration messages) 1, . . . , N including the C-SN configurations 1, . . . . N, respectively, generate conditional (re) configuration fields/IEs 1, . . . , N including the RRC container messages 1, . . . , N and the condition configurations 1, . . . , N, respectively, and transmits 312 the RRC reconfiguration message including the conditional configuration fields/IEs to the UE 102.

In some implementations, the MN 104A can transmit an SN message (e.g., SN Reconfiguration Complete message) to the C-SN 106A to indicate that the UE 102 receives the C-SN configuration(s), in response to or after receiving the RRC reconfiguration complete message. In other implementations, the MN 104A refrains from sending an SN message to the C-SN 106 to indicate the UE 102 receives the C-SN configuration(s). Events 304, 306, 307, 308, 310, 312 and 314 collectively define a conditional SN addition preparation procedure 380.

After receiving 314 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message, the MN 104A can (determine to) send 316 an Early Status Transfer message to the C-SN 106A to transfer a COUNT value of the first downlink SDU that the MN 104A forwards to the C-SN 106A or a COUNT value for discarding of already forwarded downlink SDUs for each of DRB(s) of the UE 102. The Early Status Transfer message may be an Early Sequence Number Status Transfer message. The MN 104A can send 316 the Early Status Transfer message without receiving an interface message indicating the UE 102 connects to the C-SN 106A.

After performing 380 the conditional SN addition preparation procedure to configure the C-SN 106A as a C-SN, the MN 104A may transmit 316 the Early Status Transfer message to the C-SN 106A. More particularly, after performing 380 an SN-related procedure with the C-SN 106A, the MN may determine 317 whether the SN-related procedure is a conditional procedure or is an immediate procedure. In response to determining 317 that the SN-related procedure is a conditional procedure (and, correspondingly, that early data forwarding is necessary), the MN transmits 316 the Early Status Transfer message.

The UE 102 may use the one or more conditions to determine whether to connect to the one of the C-PSCell(s). If the UE 102 detects 318 that a condition for connecting to C-PSCell 126A is satisfied, the UE 102 connects to the C-PSCell 126A. That is, the condition (or “triggering condition”) triggers the UE 102 to connect to the C-PSCell 126A or to execute the C-SN configuration concerning the C-PSCell 126A. However, if the UE 102 does not detect that the condition is satisfied, the UE 102 does not connect to the C-PSCell 126A. In response to the detection, the UE 102 initiates a random access procedure on the C-PSCell 126A. In response to the initiation, the UE 102 performs 320 the random access procedure with the C-SN 106A via the C-PSCell 126A. In response to the detection or initiation 318, the UE 102 sends 322 an RRC reconfiguration complete message to the MN 104A. The UE 102 can send 322 the RRC reconfiguration complete message before, during or after the random access procedure.

The UE 102 may indicate the selected C-PSCell, the C-PSCell 126A, in the RRC reconfiguration complete message that the UE 102 transmits 322. For example, the RRC reconfiguration complete message may indicate that the UE 102 has executed one of the C-SN configuration(s) or has connected to a C-PSCell of a particular C-SN (i.e., the C-PSCell 126A). The RRC reconfiguration complete message, for example, may include a condition configuration ID corresponding to the particular C-SN configuration (as shown in FIG. 3A). As another example, the UE 102 can include a C-PSCell ID for the C-PSCell 126A in the RRC reconfiguration complete message. Thus, based on the RRC reconfiguration complete message, the MN 104A determines which C-PSCell was selected by the UE 102.

In response to or after receiving 322 the RRC reconfiguration complete message, the MN 104A sends 324 an SN message to the C-SN 106A. In some implementations, the SN message can be an SN Reconfiguration Complete message. In other implementations, the SN message can be an RRC Transfer message. In yet other implementations, the SN message can be a new interface message (e.g., XnAP or X2AP message) defined in 3GPP 38.423 or 36.423 release 17 specification. In some implementations, the UE 102 can include an SN RRC message (e.g., RRCReconfigurationComplete message) in the RRC reconfiguration complete message that the UE 102 transmits at event 322. In such cases, the MN 104A can include the SN RRC message in the SN message.

In some implementations, the random access procedure can be a four-step random access procedure or a two-step random access procedure. In other implementations, the random access procedure can be a contention-based random access procedure or a contention-free random access procedure. For example, the UE 102 may include RRC reconfiguration complete message in a message 3 of the four-step random access procedure or in a message A of the two-step random access procedure.

After the UE 102 and the C-SN 106A successfully complete the random access procedure (i.e., successful contention resolution) with each other via the C-PSCell 126A, the C-PSCell 126A and the C-SN 106A becomes a PSCell and an SN, respectively, for the UE 102. After the C-SN 106A successfully completes the random access procedure with the UE 102, the C-SN 106A can send 326 an interface message (e.g., SN Modification Required message or a success indication message) including PSCell information of PSCell 126A to the MN 104A. The PSCell information can include a cell global identity (CGI), a physical cell identity (PCI), and/or an absolute radio frequency channel number (ARFCN) identifying a DL carrier frequency of the PSCell 126A. In some implementations, the C-SN 106A can send 326 the interface message in response to or after receiving the SN message.

In response to or after receiving 322 the RRC reconfiguration complete message or 326 the interface message, the MN 104A applies 328 the coordination information and/or the MN restriction information. In response to applying 328 the coordination information and/or the MN restriction information, the MN 104A can send 330 an RRC reconfiguration message including configuration parameters to the UE 102. In some implementations, the configuration parameters 330 may reconfigure or release (values of) configuration parameters that the UE 102 uses to communicate with the MN 104A. In other implementations, the configuration parameters 330 may be new configuration parameters to configure the UE 102 to communicate with the MN 104A. In response to the RRC reconfiguration message 330, the UE 102 can send 332 an RRC reconfiguration message to the MN 104A. The events 322, 324, 326, 328, 330, and 332 are collectively referred to in FIG. 3A as a Conditional SN Addition execution procedure 390.

In response to or after receiving 332 the RRC reconfiguration complete message or 326 the interface message, the MN 104A can send 334 an Sequence Number Status Transfer message to transfer uplink PDCP SN and Hyper Frame Number (HFN) receiver status and/or downlink PDCP SN and HFN transmitter status for each of DRB(s) of the UE 102. In contrast to event 316, the MN 104A sends 334 a (non-early) Sequence Number Status Transfer message.

After the UE 102 successfully completes 320 the random access procedure, the UE 102 communicates 336 with the MN and with the SN via the C-PSCell 126A in accordance with the C-SN configuration configuring the C-PSCell 126A.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in this case can use the C-SN configuration to communicate with the SN 106A without relying on an SN configuration. On the other hand, the C-SN configuration in other cases can include a “delta” configuration, or one or more configurations that augment a previously received SN configuration. In these cases, the UE 102 can use the delta C-SN configuration together with the SN configuration to communicate with the SN 106A.

The C-SN configuration can include multiple configuration parameters for the UE 102 to apply when communicating with the SN 106A via a C-PSCell 126A. The multiple configuration parameters may configure the C-PSCell 126A and zero, one, or more candidate secondary cells (C-SCells) of the SN 106A to the UE 102. The multiple configuration parameters may configure radio resources for the UE 102 to communicate with the SN 106A via the C-PSCell 126A and zero, one, or more C-SCells of the SN 106A. The multiple configuration parameters may configure zero, one, or more radio bearers. The one or more radio bearers can include an SRB and/or one or more DRBs.

In some implementations, the C-SN configuration can include a group configuration (CellGroupConfig) IE that configures the C-PSCell 126A and zero, one, or more C-SCells of the SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig 1E conforming to 3GPP specification 38.331 v16.5.0 or an earlier version. The full configuration indication may be a field or an IE conforming to 3GPP specification 38.331 v16.5.0 or an earlier version. In other implementations, the C-SN configuration can include an SCG-ConfigPartSCG-r12 IE that configures the C-PSCell 126A and zero, one, or more C-SCells of the SN 106A. In some implementations, the C-SN configuration is an RRCConnectionReconfiguration message, RRCConnectionReconfiguration-IEs, or the ConfigPartSCG-r12 IE conforming to 3GPP specification 36.331 v16.5.0 or an earlier version. The full configuration indication may be a field or an IE conforming to 3GPP specification 36.331 or an earlier version.

Still referring to FIG. 3A, the base station 106A in some cases can include the CU 172 and one or more DUs 174 as illustrated in FIG. 1C. For each of the C-SN configuration(s), the one or more DUs 174 can generate the C-SN configuration. Alternatively, for each of the C-SN configuration(s), the one or more DUs 174 can generate a portion of the C-SN configuration and the CU 172 may generate the rest of the C-SN configuration. For example, the UE 102 performs 320 the random access procedure with a first DU of the one or more DUs 174 operating the (C-)PSCell 126A and the first DU may identify the UE 102 in the random access procedure. In this case, the UE 102 communicates 336 with the SN 106A via the first DU.

The first DU of the C-SN 106A operating the C-PSCell 126A may generate the C-SN configuration configuring the C-PSCell 126A or a portion of the C-SN configuration and send the C-SN configuration or the portion of the C-SN configuration to the CU 172. In cases of generating a portion of the C-SN configuration, the CU 172 generates the rest of the C-SN configuration. In some scenarios or implementations, the first DU generates each of the other C-SN configuration(s). Alternatively, for each of the other C-SN configuration(s), the first DU generates a portion of the C-SN configuration and the CU 172 generates the rest of the C-SN configuration. In other scenarios or implementations, the first DU generates at least one first C-SN configuration in the C-SN configuration(s). Alternatively, for each of the at least one first C-SN configuration, the first DU generates a portion of the C-SN configuration and the CU 172 generates the rest of the C-SN configuration. A second DU of the C-SN 106A, the second DU included in the one or more DUs 174, generates at least one second C-SN configuration in the C-SN configuration(s). Alternatively, for each of the at least one second C-SN configuration, the second DU generates a portion of the C-SN configuration and the CU 172 generates the rest of the C-SN configuration.

Referring next to FIG. 3B, a scenario 300B is similar to the scenario 300A. However, in the scenario 300B, the MN 104A receives coordination information from the C-SN after the UE has connected to a particular cell of the SN. More particularly, in response to the SN Addition Request message that the C-SN 106A receives 304, the C-SN 106A transmits 305 an SN Addition Request Acknowledge message including ID(s) of the C-PSCell(s) and the C-SN configuration(s) to the MN 104A and omitting coordination information. The SN Addition Request Acknowledge message might include an SN-to-MN Container. In some implementations, the SN-to-MN container is an S-NG-RAN node to M-NG-RAN node Container IE, which has been defined since the 3GPP 38.423 Release 15 specification. In other implementations, the SN-to-MN container is an SgNB to MeNB Container IE, which has been defined since the 3GPP 36.423 Release 15 specification. In some implementations, for each of the C-SN configuration(s), the C-SN 106A generates a CG-Config IE including the C-SN configuration and includes the CG-Config(s) in the SN Addition Request Acknowledge message. At a later time, when the C-SN 106A transmits 327 an interface message to the MN 104A after the UE 102 connects to the C-SN 106A, the C-SN 106A includes in the interface message the coordination information.

In some implementations, the interface message 327 is an existing X2AP message defined in 3GPP specification 36.423 v16.6.0 or an earlier version, or an existing XnAP message defined in 3GPP specification 38.423 v.16.6.0 or an earlier version. In other implementations, the interface message 327 is a new X2AP message defined in 3GPP release 17 specification 36.423, or a new XnAP message defined in 3GPP release 17 specification 38.423. In some implementations, the interface message 327 is another type of message such as an SN Modification Required message, an NG-RAN node Configuration Update message, or a E-UTRA-NR Cell Resource Coordination Request message. The interface message 327 may include an SgNB Coordination Assistance Information IE or a NR Resource Coordination Information IE for Physical Resource Block (PRB) coordination.

After receiving 327 the coordination information, the MN 104A applies 328 the coordination information and/or the MN restriction information. The MN 104A may transmit 333 an SN Modification Confirm message to the C-SN 106A (now SN 106A) after applying 328 the coordination information and/or MN restriction information.

Events 304, 306, 307, 305, 312 and 314 collectively define a Conditional SN Addition preparation procedure 381. Events 322, 324, 327, 328, 330, 332, and 333 collectively define a Conditional SN Addition execution procedure 391.

Turning to FIG. 3C, during the scenario 300C, the C-SN 106A provides, to the MN 104, the same coordination information for all candidate cells during an SN addition request procedure, and the MN applies the coordination information immediately. In particular, when the C-SN 106A generates 307 coordination information, the C-SN 106A generates identical coordination information for all of the C-PSCell(s) (or generates one set of coordination information that applies to all of the C-PSCell(s)). Thus, coordination parameters included in the coordination information are identical for all of the C-PSCell(s).

The C-SN 106A transmits 308 an SN Addition Request Acknowledge message including C-PSCell ID(s), CG-Config(s), and the coordination information. The MN 104A determines 313 whether the coordination information is identical for the C-PSCell(s). For example, the MN 104A can decode coordination information for each of the C-PSCell(s) and determine 317 that the coordination information is identical for each of the C-PSCell(s). As another example, the MN 104A can determine 317 that the coordination information is identical for all of the C-PSCell(s) if the coordination information includes one set of coordination information for all C-PSCell(s). After or in response to determining 313 that the coordination information is identical for all C-PSCell(s), the MN 104A applies 311 the coordination information and/or MN restriction information. Events 304, 306, 307, 308, 313, 311, 312, and 314 collectively define a Conditional SN Addition preparation procedure 382.

The scenario 300C then proceeds similarly to the scenario 300A, except that the MN 104A has already applied 311 the coordination information and/or MN restriction information before the UE 102 connects 320 to the C-PSCell 126A. Events 322, 324, and 326 collectively define a Conditional SN Addition execution procedure 392.

Turning to FIGS. 3D-3E, scenarios 300D and 300E may each be similar to any one of the scenarios 300A-300C. However, the scenarios 300D and 300E include an MN-initiated conditional SN change procedure and an SN-initiated conditional SN change procedure, respectively. Referring first to FIG. 3D, in the scenario 300D the UE 102 operates 301 in dual connectivity (DC) with the MN 104A and a base station 106B, operating as an S-SN. The UE 102 communicates with the S-SN 106B via a PSCell in accordance with an S-SN configuration.

At a later time, the MN 104A determines to configure the base station 106A as a C-SN for conditional PSCell change (CPC). The MN 104A can make this determination in a similar manner as described above for CPA in FIG. 3A. To configure the C-SN 106A as a C-SN, the MN 104A can perform any one of the Conditional SN Addition preparation procedures 380, 381, or 382 with the C-SN 106A and the UE 102. After configuring the C-SN 106A, the MN 104A may transmit 340 an interface message to the S-SN 106B. The S-SN 106B may transmit 342 an Early Status Transfer message to the MN 104A. The S-SN 106B may transmit 342 the Early Status Transfer message in response to receiving 340 the interface message. The MN 104A also transmits 316 an Early Status Transfer message to the C-SN 106A, as in FIG. 3A.

In some implementations, the interface message 340 is an existing X2AP message defined in 3GPP specification 36.423 v16.6.0 or earlier version. For example, the interface message 340 can be an X2-U Address Indication or a Data Forwarding Address Indication. In one implementation, the MN 104 can include an existing field or a new field in the existing X2AP message to indicate to the S-SN 106B to send 342 an Early Status Transfer message. In another implementation, the MN 104 can include a new field in the existing X2AP message to indicate to the SN 106B that the UE 102 has been configured with a conditional configuration for CPC. In other implementations, the interface message 340 is a new XnAP message defined in a 3GPP release 17 specification. For example, the interface message 340 can be an Early Status Transfer Triggering message or a CPC Triggered message or a Conditional PSCell Change Notification.

In some implementations, the interface message 340 is an existing XnAP message defined in 3GPP specification 38.423 v16.6.0 or an earlier version. For example, the interface message 340 can be an Xn-U Address Indication. In one implementation, the MN 104 can include an existing field or a new field in the existing XnAP message to indicate to the S-SN 106B to send 342 an Early Status Transfer message. In another implementation, the MN 104 can include a new field in the existing XnAP message to indicate to the SN 106B that the UE 102 has been configured with a conditional configuration for CPC. In other implementations, the interface message 340 is a new XnAP message defined in a 3GPP release 17 specification. For example, the interface message 340 can be an Early Status Transfer Triggering message or a CPC Triggered message or a Conditional PSCell Change Notification.

After the UE 102 detects 318 a condition for connecting to the C-PSCell 126A and connects 320 to the C-SN 106A during via a random access procedure, the MN 104A, UE 102, and C-SN 106A can perform one of the Conditional SN Addition execution procedures 390, 391, or 392, based on which the Conditional SN Addition preparation procedure was performed previously during the scenario 300D (e.g., if the MN 104A and C-SN 106A perform the Conditional SN Addition preparation procedure 380, then the MN 104A and C-SN 106A can perform the Conditional SN Addition execution procedure 390).

After the Conditional SN Addition execution procedure 390, 391, or 392, the MN 104A transmits 344 an SN Release Request message to the S-SN 106B to release the S-SN 106B from DC. The SN Release Request message may trigger the S-SN 106B to release the PSCell for the UE 102. In response to the SN Release Request message, the S-SN 106B transmits 346 an SN Release Request Acknowledge message to the MN 104A. The S-SN 106B may also transmit 348 an SN Status Transfer message to the MN 104A, and the MN 104A can transmit 334 an SN Status Transfer message to the C-SN 106A. Further, the MN 104A may transmit 350 a UE Context Release message to the S-SN 106B to instruct the S-SN 106B to release a UE context for the UE 102.

Turning to FIG. 3E, the scenario 300E is similar to the scenario 300D except that the CPC is SN-initiated. The S-SN 106B determines to configure the base station 106A as a C-SN for CPC. The S-SN 104B can make this determination based on measurement result(s) from the UE 102, for example, similar to the manner in which the MN 104A can determine to initiate CPA as discussed above for FIG. 3A. In response to the determination, the S-SN 106B sends 303 an SN Change Required message to the MN 104A. To configure the C-SN 106A as a C-SN, the MN 104A can perform any one of the Conditional SN Addition preparation procedures 380, 381, or 382 with the C-SN 106A and the UE 102. After configuring the C-SN 106A, the MN 104A may transmit 309 an SN Change Confirm message to the S-SN 106B. The S-SN 106B may send 342 an Early Status Transfer message to the MN 104A in response to the SN Change Confirm message.

After the UE 102 detects 318 a condition for connecting to the C-PSCell 126A and connects 320 to the C-SN 106A during via a random access procedure, the MN 104A, UE 102, and C-SN 106A can perform one of the Conditional SN Addition execution procedures 390, 391, or 392, based on which the Conditional SN Addition preparation procedure was performed previously during the scenario 300E. In contrast to FIG. 3D, the MN 104A might or might not transmit 344 an SN Release Request to the S-SN 106B, because the S-SN 106B initiated the CPC. In some implementations, instead of the SN Release Request message, the MN 104A can send to the S-SN 106B an interface message to indicate that CPC executed in response to receiving an RRC reconfiguration complete message in the conditional SN addition execution procedure. For example, the interface message can be a Conditional SN Change Success Message or an Xn-U Address Indication or an SN Change Confirm message.

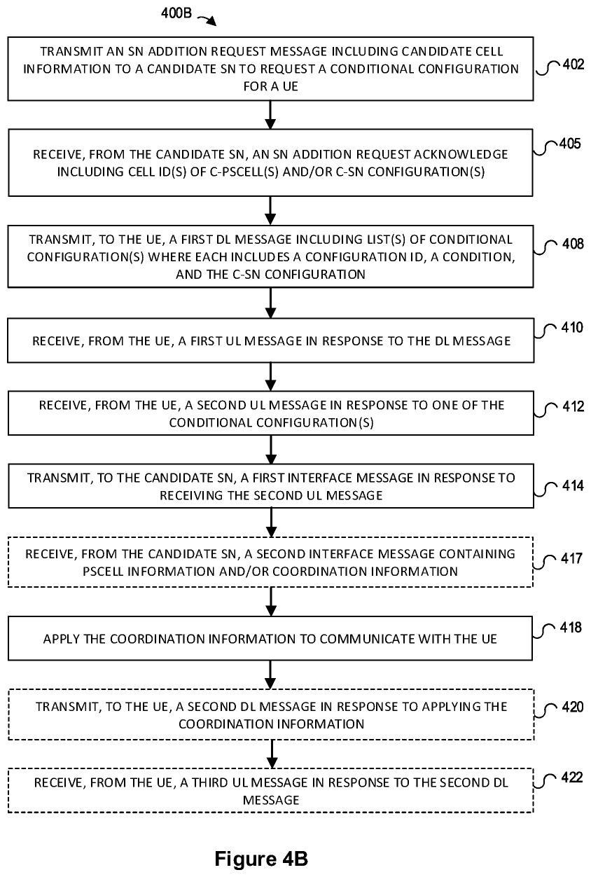

FIGS. 4A-4B, 5, 6A-6B, and 7-13 are flow diagrams depicting example methods that a base station (e.g., the base station 104A, 104B, 106A, or 106B) can implement to support conditional SN-related procedures. As indicated at various points throughout this disclosure, the example methods depicted in FIGS. 4A-4B, 5, 6A-6B, and 7-13 may be implemented during the scenarios 300A-300E described above.

Referring to FIGS. 4A-4B, a base station, such as the MN 104A of FIGS. 3A-3E, can manage configurations for an SN-related procedure for a UE by implementing methods 400A-400B. For example, to apply coordination information, the MN 104A during the scenario 300A may perform the method 400A, and the MN 104A during the scenario 300B may perform the method 400B. Generally speaking, similar blocks in FIGS. 4A-4B are labeled with the same reference numbers (e.g., block 402 in FIG. 4A is equivalent to block 402 in FIG. 4B).

Referring first to FIG. 4A, during the method 400A, at block 402, the base station transmits an SN Addition Request message including candidate cell information to a C-SN to configure a conditional configuration for a UE (e.g., event 304 of FIGS. 3A-3C). The base station at block 404 receives, from the C-SN, an SN Addition Request Acknowledge message including Cell ID(s) of C-PSCell(s), C-SN configuration(s), and/or Coordination information (e.g., event 308 of FIGS. 3A and 3C, event 305 of FIG. 3B). At block 406, the base station refrains from applying the coordination information before the UE connects to the C-SN. At block 408, the base station transmits, to the UE, a DL message including list(s) of conditional configuration(s), where each includes a configuration ID, a condition configuration, and the C-SN configuration (e.g., event 312 of FIGS. 3A-3C). At block 410, the base station receives, from the UE, a first UL message in response to the DL message (e.g., event 314 of FIGS. 3A-3C). At block 412, the base station receives, from the UE, a second UL message in response to one of the conditional configuration(s) (e.g., event 322 of FIGS. 3A-3C). At block 414, the base station transmits, to the C-SN, a first interface message in response to receiving the second UL message (e.g., event 324 of FIGS. 3A-3C). At block 416, the base station may receive, from the C-SN, a second interface message containing PSCell information (e.g., event 326 of FIGS. 3A-3C). The base station at block 418 may apply the coordination information to communicate with the UE (e.g., event 328 of FIGS. 3A-3B).

Referring next to FIG. 4B, an example method 400B begins at block 402, where the base station transmits an SN Addition Request message including candidate cell information to the C-SN to configure a conditional configuration for a UE (e.g., event 304 of FIGS. 3A-3C). The base station at block 404 receives, from the C-SN, an SN Addition Request Acknowledge message including cell ID(s) of C-PSCell(s), C-SN configuration(s), and/or Coordination information (e.g., event 308 of FIGS. 3A and 3C, event 305 of FIG. 3B). At block 408, the base station transmits, to the UE, a first DL message including list(s) of conditional configuration(s), where each includes a configuration ID, a condition configuration, and the C-SN configuration (e.g., event 312 of FIGS. 3A-3C). At block 410, the base station receives, from the UE, a first UL message in response to the DL message (e.g., event 314 of FIGS. 3A-3C). At block 412, the base station receives, from the UE, a second UL message in response to one of the conditional configuration(s) (e.g., event 322 of FIGS. 3A-3C). At block 414, the base station may transmit, to the C-SN, a first interface message in response to receiving the second UL message (e.g., event 324 of FIGS. 3A-3C). At block 417, the base station may receive, from the C-SN, a second interface message containing PSCell information and/or coordination information (e.g., event 326 of FIGS. 3A-3C). The base station at block 418 may apply the coordination information to communicate with the UE (e.g., event 328 of FIGS. 3A-3B). The base station at block 420 may transmit, to the UE, a second DL message in response to applying the coordination information (e.g., event 330 of FIGS. 3A-3C). The base station at block 422 may receive, from the UE, a third UL message in response to the second DL message (e.g., event 332 of FIGS. 3A-3C).

FIGS. 5-13 are flow diagrams of methods performed by a base station operating as an MN (e.g., the MN 104A of FIGS. 3A-3E), SN, or as a C-SN (e.g., the C-SN 106A of FIGS. 3A-3E), to manage configurations during SN-related procedures. More specifically, FIGS. 5-13 illustrate how an MN may handle receiving (or not receiving) an SN-to-MN container during an SN-related procedure depending on whether the SN-related procedure is a conditional SN-related procedure, and how an SN (or C-SN) can determine whether and how to utilize an SN-to-MN container during an SN-related procedure depending on whether the SN-related procedure is a conditional SN-related procedure.

Referring next to FIG. 5, a base station operating as an MN (e.g., the MN 104A of FIGS. 3A-3E) performs a method 500 to manage configurations for an SN-related procedure for a UE, such as the UE 102. In method 500, the MN determines how to handle a received SN-to-MN container during an SN-related procedure based on whether the SN-related procedure is conditional.

The method 500 begins at block 502, where the MN sends an SN Request message to an SN to perform an SN-related procedure for a UE (e.g., event 304 of FIGS. 3A-3C). At block 504, the MN receives an SN Request Acknowledge message including an SN-to-MN container from the SN in response to the SN Request message (e.g., event 308 of FIGS. 3A and 3C, event 305 of FIG. 3B). The MN at block 506 checks whether the SN-related procedure is a conditional SN-related procedure. If the SN-related procedure is a conditional SN-related procedure, the MN proceeds to block 512, where the MN ignores the SN-to-MN container and does not use the contents of the SN-to-MN container for configuring the UE to communicate with the SCG. In some implementations, ignoring the SN-to-MN container means to ignore the whole CG-Config message included in the SN-to-MN container. In other implementations, ignoring the SN-to-MN container means to ignore part of the CG-Config message, such as the scg-CellGroupConfig IE and/or the scg-RB-Config IE. If the SN-related procedure is not a conditional SN-related procedure at block 506, the MN proceeds to block 508, where the MN retrieves an RRC message from the SN-to-MN container. The MN at block 510 transmits the RRC message to the UE. The RRC message may include an SCG configuration that the UE can use to connect to the SN.

In some implementations, the SN-to-MN container is an S-NG-RAN node to M-NG-RAN node Container IE, which has been defined since the 3GPP 38.423 Release 15 specification. In other implementations, the SN-to-MN container is an SgNB to MeNB Container IE, which has been defined since the 3GPP 36.423 Release 15 specification. The SN-related procedure may be an SN Addition Preparation procedure for SN Addition or MN-initiated SN Change, or may be in response to an SN-initiated SN Change. The SN Request message may be an SN Addition Request (e.g., S-Node Addition Request or SgNB Addition Request) message or an SN Modification Request (e.g., S-Node Modification Request or SgNB Modification Request) message, and the SN Request Acknowledge message may be an SN Addition Request Acknowledge (e.g., S-Node Addition Request Acknowledge or SgNB Addition Request Acknowledge) message or an SN Modification Request Acknowledge (e.g., S-Node Modification Request Acknowledge or SgNB Modification Request Acknowledge) message.

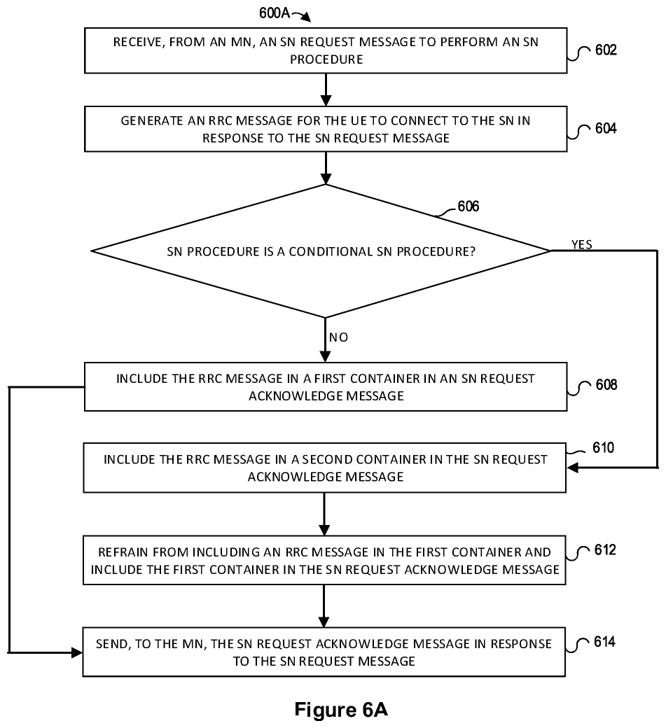

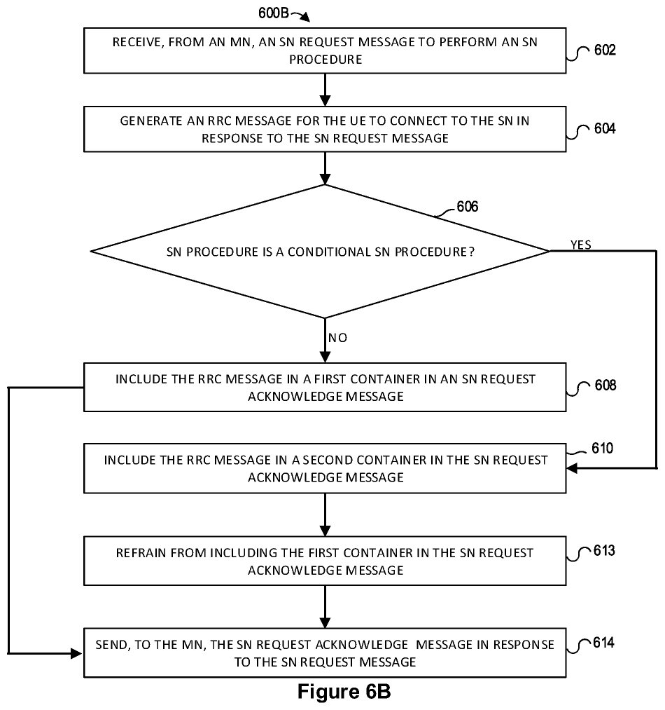

Referring next to FIG. 6A, method 600A according to an exemplary embodiment is performed by a base station operating as an Sn or a C-SN (e.g., 106A in FIGS. 3A-3E) for managing configurations for SN-related procedure for a UE, such as the UE 102. The method can be implemented in a base station operating as an SN or a C-SN, such as the C-SN 106A of FIGS. 3A-3E. The base station operating as SN can utilize the method 600A to determine whether to utilize an SN-to-MN container to transmit the configurations, for example.

The method 600A begins at block 602, where the base station, which may be an SN or a C-SN, receives an SN Request message from an MN to perform an SN-related procedure (e.g., event 304 of FIGS. 3A-3C). At block 604, in response to the SN Request message, the base station generates an RRC message for the UE to use to connect to the SN (e.g., an RRC message including a configuration for the UE to use to connect to the SN). The base station at block 606 checks whether the SN-related procedure is a conditional SN-related procedure. If the SN-related procedure is not a conditional SN-related procedure, the base station proceeds to block 608, where the base station includes the RRC message in a first container in the SN Request acknowledge message. The base station then proceeds to block 614, where the base station sends the SN Request Acknowledge message to the MN in response to the SN Request message (e.g., event 308 of FIGS. 3A and 3C, event 305 of FIG. 3B). If the SN-related procedure is a conditional SN-related procedure at block 606, the base station proceeds to block 610, where the base station includes the RRC message in a second container in the SN Request acknowledge message. At block 612, the base station refrains from including an RRC message in the first container and includes the first container in the SN Request Acknowledge message. The base station then proceeds to block 614, described above.

In some implementations, the first container is an S-NG-RAN node to M-NG-RAN node Container IE, for example, the one defined in the 3GPP 38.423 Release 15 specification. In other implementations, the first container is an SgNB to MeNB Container IE, which has been defined in the 3GPP 36.423 Release 15 specification. In some implementations, the second container is a specific container for containing one or more C-SN configurations, which may be an RRC container included in a Conditional PSCell Addition Information Acknowledge IE or a Conditional PSCell Modification Information Acknowledge IE. In other implementations, the second container is a cell-specific CG-Config message, which has been defined since the 3GPP 38.331 Release 15 specification.

Referring next to FIG. 6B, method 600B is an exemplary embodiment similar to the method 600A. In particular, blocks labeled with the same reference numbers in FIGS. 6A-6B are the same. However, during the method 600B, the base station may determine, in scenarios in which the SN-related procedure is a conditional procedure, to exclude the first container from the SN Request Acknowledge message. This is in contrast to the method 600A, in which the base station includes the first container, excluding the RRC message, in the SN Request Acknowledge message. More specifically, after block 610, at block 613, the base station refrains from including the first container in the SN Request Acknowledge message. The base station then proceeds to block 614, where the base station sends the SN Request Acknowledge message to the MN in response to the SN Request message (e.g., event 308 of FIGS. 3A and 3C, event 305 of FIG. 3B).

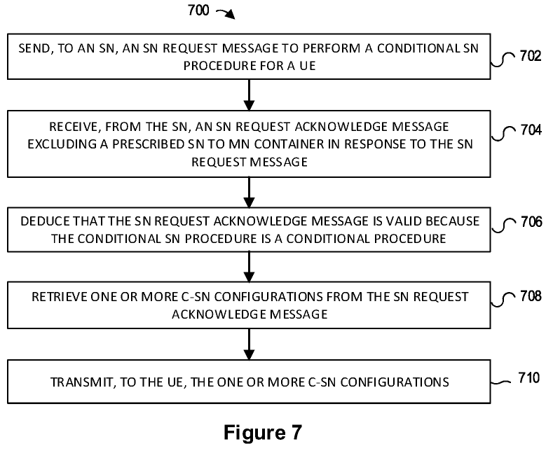

Referring next to FIG. 7, a base station operating as an MN (e.g., the MN 104A of FIGS. 3A-3E) can implement a method 700 for handling an SN Request Acknowledge message that does not include an SN-to-MN container.

The method 700 begins at block 702, where the MN sends an SN Request message to an SN to perform a conditional SN-related procedure for a UE (e.g., event 304 of FIGS. 3A-3C). At block 704, the MN receives, from the SN, an SN Request Acknowledge message excluding a mandatory (i.e., prescribed by Release 15 and later releases 3GPP specifications) SN-to-MN container in response to the SN Request message (e.g., event 308 of FIGS. 3A and 3C, event 305 of FIG. 3B). The MN at block 706 deduces that the SN Request Acknowledge message is valid, because the conditional SN-related procedure is a conditional procedure. Determining that the received SN Request Acknowledge message is valid may include considering the absence of the SN-to-MN container is not an Abstract Syntax Error and, therefore, not initiating a follow-up Error Indication, SN Release, or UE Context Release procedure (procedures that would regularly be performed in case of the absence of the mandatory SN-to-MN container). At block 708, the MN retrieves one or more C-SN configurations from the SN Request Acknowledge message. The MN at block 710 transmits the one or more C-SN configurations to the UE (e.g., event 312 of FIGS. 3A-3C).

In some implementations, the SN-to-MN container is an S-NG-RAN node to M-NG-RAN node Container IE, which has been defined since the 3GPP 38.423 Release 15 specification. In other implementations, the SN-to-MN container is an SgNB to MeNB Container IE, which has been defined since the 3GPP 36.423 Release 15 specification.

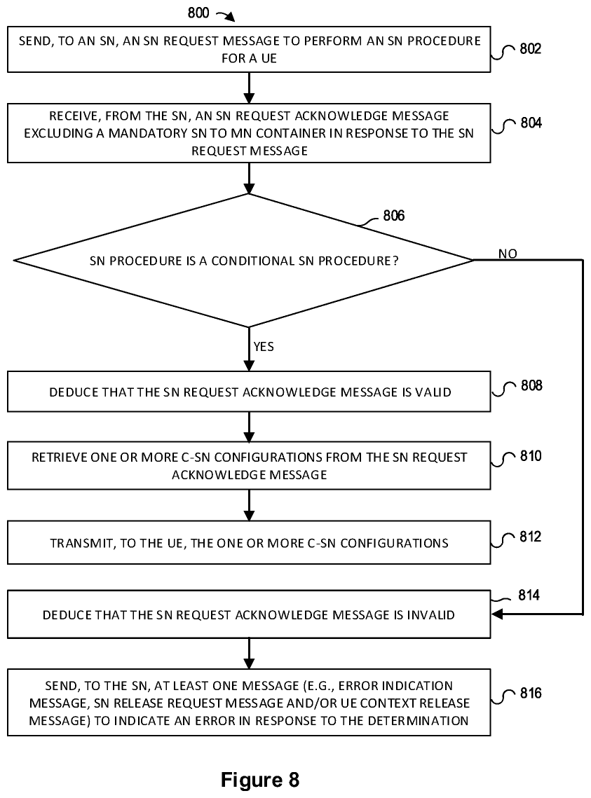

Referring next to FIG. 8, a method 800 is another method for handling an SN Request Acknowledge message that does not include an SN-to-MN container. This method can be implemented by a base station operating as an MN (e.g., the MN 104A of FIGS. 3A-3E), similar to the method 700.

The method 800 begins at block 802, where the MN sends an SN Request message to an SN to perform a conditional SN-related procedure for a UE (e.g., event 304 of FIGS. 3A-3C). At block 804, the MN receives, from the SN, an SN Request Acknowledge message excluding a mandatory SN-to-MN container in response to the SN Request message (e.g., event 308 of FIGS. 3A and 3C, event 305 of FIG. 3B). The MN at block 806 determines whether the SN-related procedure is a conditional SN-related procedure. If the SN-related procedure is a conditional SN-related procedure, the MN proceeds to block 808, where the MN deduces that the SN Request Acknowledge message is valid. Similar to block 706 above, deducing that the received SN Request Acknowledge message is valid may include not treating the absence of the SN-to-MN container as an Abstract Syntax Error and not initiating a follow-up Error Indication, SN Release, or UE Context Release procedure related to the absence of the mandatory SN-to-MN container. At block 810, the MN retrieves one or more C-SN configurations from the SN Request Acknowledge message. The MN at block 812 transmits the one or more C-SN configurations to the UE (e.g., event 312 of FIGS. 3A-3C). If the SN-related procedure is not a conditional SN-related procedure at block 806, the MN proceeds to block 814, where the MN deduces that the SN Request Acknowledge message is invalid. At block 816, the MN sends at least one message (e.g., Error Indication message, SN Release Request message and/or UE Context Release message) to the SN to indicate an error in response to the determination.

In some implementations, the SN-to-MN container is an S-NG-RAN node to M-NG-RAN node Container IE, which has been defined since the 3GPP 38.423 Release 15 specification. In other implementations, the SN-to-MN container is an SgNB to MeNB Container IE, which has been defined since the 3GPP 36.423 Release 15 specification.

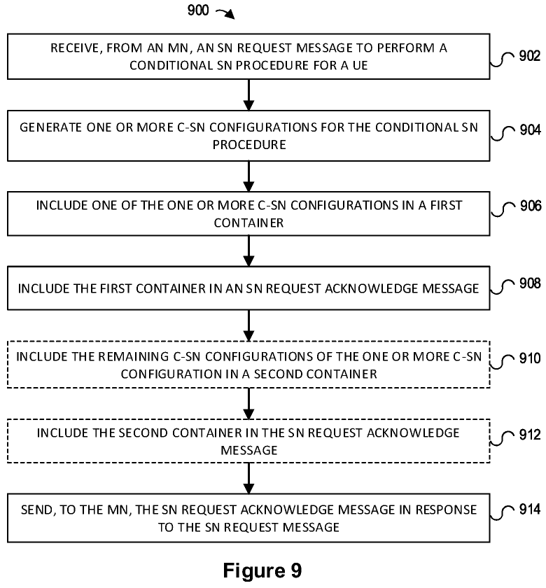

Referring next to FIG. 9, a base station (e.g., an SN or a C-SN such as the C-SN 106A of FIGS. 3A-3E) can implement a method 900 for transmitting, to an MN (e.g., the MN 104A), one or more configurations for an SN-related procedure for a UE.

The method begins at block 902, where the base station receives an SN Request message from an MN to perform a conditional SN-related procedure for a UE (e.g., event 304 of FIGS. 3A-3C). At block 904, the base station generates one or more C-SN configurations for the conditional SN-related procedure. The base station at block 906 includes one of the one or more C-SN configurations in a first container. At block 908, the base station includes the first container in an SN Request Acknowledge message. At block 910, the base station may include the remaining C-SN configurations of the one or more C-SN configurations in a second container. At block 912, the base station may include the second container in an SN Request Acknowledge message. The base station at block 914 sends the SN Request Acknowledge message to the MN in response to the SN Request message (e.g., event 308 of FIGS. 3A and 3C, event 305 of FIG. 3B).

In some implementations, the first container is an S-NG-RAN node to M-NG-RAN node Container IE, which has been defined since the 3GPP 38.423 Release 15 specification. In other implementations, the first container is an SgNB to MeNB Container IE, which has been defined since the 3GPP 36.423 Release 15 specification. In some implementations, the second container is a specific for containing one or more C-SN configurations, which may be an RRC container included in a Conditional PSCell Addition Information Acknowledge IE. In other implementations, the second container is a cell-specific CG-Config message, which has been defined since the 3GPP 38.331 Release 15 specification.

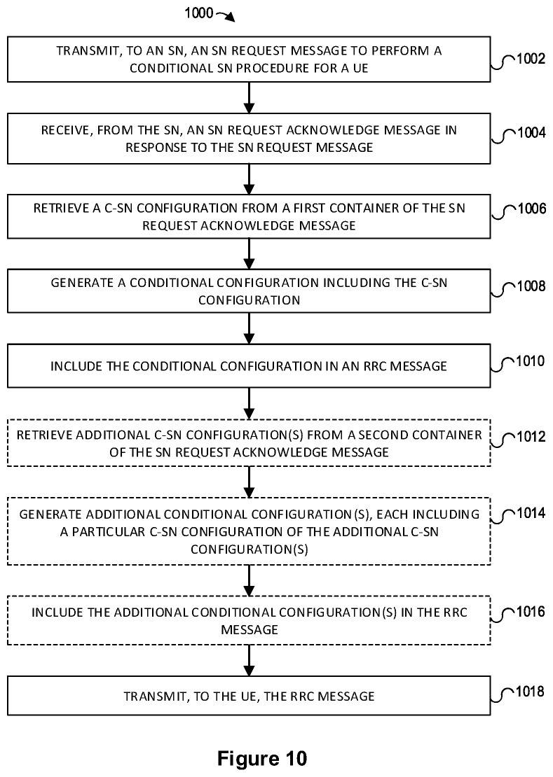

Referring next to FIG. 10, a base station operating as an MN (e.g., the MN 104A of FIGS. 3A-3E) can implement a method 1000 for receiving, from an SN (e.g., the C-SN 106A), one or more configurations for an SN-related procedure for a UE. The method 1000 is similar to the method 900, but includes operations implemented by the MN rather than the SN.

The method begins at block 1002, where the base station sends an SN Request message to an SN to perform a conditional SN-related procedure for a UE (e.g., event 304 of FIGS. 3A-3C). At block 1004, the base station receives an SN Request Acknowledge message from the SN in response to the SN Request message (e.g., event 308 of FIGS. 3A and 3C, event 305 of FIG. 3B). At block 1006, the base station retrieves a C-SN configuration from a first container of the SN Request Acknowledge message. At block 1008, the base station generates a conditional configuration including the C-SN configuration. The base station at block 1010 includes the conditional configuration in an RRC message. The base station at block 1012 may retrieve additional C-SN configuration(s) from a second container of the SN Request Acknowledge message. If the base station retrieves the additional C-SN configuration(s), the base station at block 1014 generates additional conditional configuration(s), each including a particular C-SN configuration of the additional C-SN configuration(s). At block 1016, the base station includes the additional conditional configuration(s) in the RRC message. At block 1018, the base station transmits the RRC message to the UE (e.g., event 312 of FIGS. 3A-3C).

In some implementations, the first container is an S-NG-RAN node to M-NG-RAN node Container IE, which has been defined since the 3GPP 38.423 Release 15 specification. In other implementations, the first container is an SgNB to MeNB Container IE, which has been defined since the 3GPP 36.423 Release 15 specification. In some implementations, the second container is a specific for containing one or more C-SN configurations, which may be an RRC container included in a Conditional PSCell Addition Information Acknowledge IE. In other implementations, the second container is a cell-specific CG-Config message, which has been defined since the 3GPP 38.331 Release 15 specification.

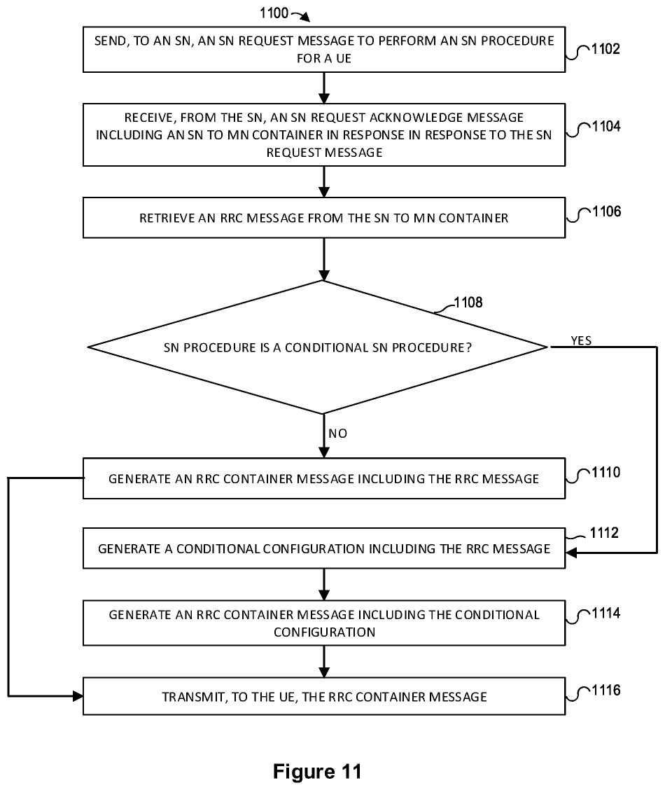

Referring next to FIG. 11, a base station operating as an MN (e.g., the MN 104A of FIGS. 3A-3E) can implement a method 1000 for transmitting, to a UE (e.g., the UE 102), configurations for an SN-related procedure for the UE.

The method begins at block 1102, where the base station sends an SN Request message to an SN to perform an SN-related procedure for a UE (e.g., event 304 of FIGS. 3A-3C). At block 1104, the base station receives an SN Request Acknowledge message including an SN-to-MN container from the SN in response in response to the SN Request message (e.g., event 308 of FIGS. 3A and 3C, event 305 of FIG. 3B). At block 1106, the base station retrieves an RRC message from the SN-to-MN container of the SN Request Acknowledge message. At block 1108, the base station checks whether the SN-related procedure is a conditional SN-related procedure. If the SN-related procedure is not a conditional SN-related procedure, the base station proceeds to block 1110, where the base station generates an RRC container message including the RRC message. The base station then at block 1116 transmits the RRC container message to the UE (e.g., event 312 of FIGS. 3A-3C). If the SN-related procedure is a conditional SN-related procedure at block 1108, the base station proceeds to block 1112, where the base station generates a conditional configuration including the RRC message. The base station at block 1114 generates an RRC container message including the conditional configuration. The base station then at block 1116 transmits the RRC Container message to the UE (e.g., event 312 of FIGS. 3A-3C).

In some implementations, the SN-to-MN container is an S-NG-RAN node to M-NG-RAN node Container IE, which has been defined since the 3GPP 38.423 Release 15 specification. In other implementations, the SN-to-MN container is an SgNB to MeNB Container IE, which has been defined since the 3GPP 36.423 Release 15 specification.

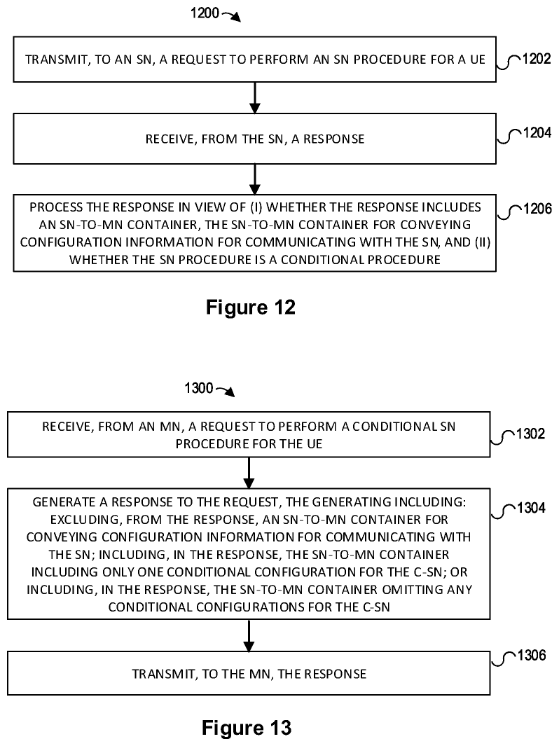

Turning to FIG. 12, a base station operating as an MN (e.g., the MN 104A) can implement a method 1200 for managing a procedure that involves a UE (e.g., the UE 102), an SN (e.g., the C-SN 106A), and the MN. At block 1202, the MN transmits, to the SN, a request to perform an SN-related procedure for the UE (e.g., event 304 of FIGS. 3A-3C, block 502 of FIG. 5, block 702 of FIG. 7, block 802 of FIG. 8, block 1002 of FIG. 10, block 1102 of FIG. 11). At block 1204, the MN receives, from the SN, a response to the request (e.g., event 308 of FIGS. 3A and 3C, event 305 of FIG. 3B, block 504 of FIG. 5, block 704 of FIG. 7, block 804 of FIG. 8, block 1004 of FIG. 10, block 1104 of FIG. 11). At block 1206, the MN processes the response in view of (i) whether the response includes an SN-to-MN container, the SN-to-MN container for conveying configuration information for communicating with the SN, and (ii) whether the SN-related procedure is a conditional SN-related procedure (e.g., blocks 506, 508, 512 of FIG. 5; block 706 of FIG. 7; blocks 806, 808, 814 of FIG. 8; block 1006 of FIG. 10; blocks 1108, 1110, 1112 of FIG. 11).

Referring to FIG. 13, a base station operating as a C-SN (e.g., the C-SN 106A) can implement a method 1300 for managing a procedure that involves a UE (e.g., the UE 102), an MN (e.g., the MN 104A), and the SN. At block 1302, the C-SN receives, from the MN, a request to perform a conditional SN-related procedure for the UE (e.g., event 304 of FIGS. 3A-3C, block 602 of FIGS. 6A-6B, block 902 of FIG. 9). At block 1304, the SN generates a response to the request. Depending on the implementation, generating the response can include: excluding, from the response, an SN-to-MN container for conveying configuration information for communicating with the SN (e.g., block 613 of FIG. 6A); including, in the response, the SN-to-MN container including only one conditional configuration for the C-SN (e.g., block 906 of FIG. 9); or including, in the response, the SN-to-MN container omitting any conditional configurations for the C-SN (e.g., block 612 of FIG. 6A). At block 1306, the SN transmits the response to the MN (e.g., event 308 of FIGS. 3A and 3C, event 305 of FIG. 3B, block 614 of FIGS. 6A-6B, block 914 of FIG. 9).

The following discussion includes observations on RRC Container content in a Conditional PSCell Addition Information IE and proposed changes to 3GPP TS 36.423 and TS 38.423. In this discussion, the timer issue at the target SN node is found for CPA or inter-SN CPC and a text proposal is made to resolve it. RAN2 #114e has agreed that: (1) In order to exchange per-PSCell parameter by reusing existing inter-node RRC message for CPAC, a list of CG-Config associated to each candidate PSCell should be sent from candidate SN to MN. (2) FFS if a list of CG-ConfigInfo from MN to candidate SN is needed. FFS if a list of CG-Config from source SN to MN is needed. (3) Discuss in Stage-3 whether new message is useful (based on signalling details). RAN3 #112 agreed to, for CPAC initiation: (1) Introduce “CPAC initiation Indication” in SN Addition Request, and SN Change Required. (2) Introduce “List of Prepared PSCell IDs” in SN Addition Request ACK. (2) FFS whether to introduce “List of Prepared PSCell IDs” in SN Change Confirm. RAN3 #112 also captured the content of the RRC container in TS 36.423 and TS 38.423, respectively, as shown in Table 2 and Table 3, below.

TABLE 2
Existing RRC Container content as defined in 36.423

| | | | IE type and | Semantics | | Assigned |
|---|---|---|---|---|---|---|
| IE/Group Name | Presence | Range | reference | description | Criticality | Criticality |
| Conditional PSCell | O | | | | YES | ignore |
| Addition Information | | | | | | |
| Acknowledge | | | | | | |
| >Candidate PSCell | | 1 | | | — | — |
| ID List | | | | | | |
| >>Candidate | | 1 . . . <maxnoofPSCellCandidate> | | | — | — |
| PSCell ID Item | | | | | | |
| >>>PSCell ID | M | | Global en-gNB | | — | — |
| | | | ID 9.2.112 | | | |
| >>>RRC | M | | OCTET STRING | Includes | — | — |
| Container | | | | RRCConnectionRecon- | | |
| | | | | figuration message | | |
| | | | | as defined in | | |
| | | | | subclause 6.2.2 | | |
| | | | | of TS 36.331[9]. | | |
| | | | | FFS whether single | | |
| | | | | or multiple RRC | | |
| | | | | containers. | | |

TABLE 3
Existing RRC Container content as defined in 38.423

| | | | IE type and | Semantics | | Assigned |
|---|---|---|---|---|---|---|
| IE/Group Name | Presence | Range | reference | description | Criticality | Criticality |
| Conditional PSCell | O | | | | YES | ignore |
| Addition Information | | | | | | |
| Acknowledge | | | | | | |
| >Candidate PSCell | | 1 | | | | |
| ID List | | | | | | |
| >>Candidate | | 1 . . . <maxnoofPSCellCandidate> | | | | |
| PSCell ID Item | | | | | | |
| >>>PSCell ID | M | | Target Cell | | | |
| | | | Global ID | | | |
| | | | 9.2.3.25 | | | |
| >>>RRC | M | | OCTET STRING | Includes | | |
| Container | | | | RRCReconfiguration | | |
| | | | | message as defined | | |
| | | | | in subclause 6.2.2 | | |
| | | | | of TS 38.331[10]. | | |
| | | | | FFS whether single | | |
| | | | | or multiple RRC | | |
| | | | | containers. | | |

There is a discrepancy for the content of the RRC container and it should be decided whether RAN3 follows the agreement made by RAN2. Also, the original RRC container in Table 2 should at least be corrected as the “RRCReconfiguration message defined in TS 38.331” as the RRC message is from SgNB.

For the RAN2's agreement, it allows it allows some flexibility in each CG-Config to contain different parameters such as selectedBandCombination, fr-InfoListSCG, scellFrequenciesSN-NR, selectedToffset-r16, or ph-InfoSCG for the corresponding PSCell for configuration coordinations with the MN.

If RAN3 decides to follow RAN2 agreement (i.e., a list of CG-Config associated to each candidate PSCell should be sent from candidate SN to MN), it should also be noted that the “SgNB to MeNB Container IE” is mandatory in the SGNB ADDITION REQUEST ACKNOWLEDGE message in TS 36.423 (and the “S-NG-RAN node to M-NG-RAN node Container IE” is mandatory in the S-NODE ADDITION REQUEST ACKNOWLEDGE message in TS 38.423). In case of CPAC preparation, it should be ignored by the MN as there is no corresponding PSCell ID and only the CG-Config(s) within the Conditional PSCell Addition Information Acknowledge IE are considered.

Therefore, the following changes are proposed to TS 36.423: (1) Add in the paragraph for CPAC in the SgNB Addition Procedure (in Section 8.7.4.2) that “The MeNB shall ignore the SgNB to MeNB Container IE in the SGNB ADDITION REQUEST ACKNOWLEDGE message.” (2) Change the content of the RRC Container to align with RAN2 agreement that the “CG-Config message defined in TS38.331” is included.

The following changes are proposed to TS 38.423: (1) Add in the paragraph for CPAC in the S-NG-RAN node Addition Procedure that “The M-NG-RAN node shall ignore the S-NG-RAN node to M-NG-RAN node Container IE in the S-NODE ADDITION REQUEST ACKNOWLEDGE message.” (2) Change the content of the RRC Container to align with the RAN2 agreement that the “CG-Config message as defined in subclause 11.2.2 of TS 38.331” is included.

The following list of examples reflects a variety of the embodiments explicitly contemplated:

Example 1 is amethod implemented in a master node (MN) for managing a procedure that involves a user equipment (UE), a secondary node (SN), and the MN. The method includes: (1) transmitting, by processing hardware of the MN to the SN, a request to perform an SN procedure for the UE; receiving, by the processing hardware from the SN, a response to the request; and (2) processing, by the processing hardware, the response based on: (i) whether the response includes an SN-to-MN container, the SN-to-MN container for conveying configuration information for communicating with the SN, and (ii) whether the SN procedure is a conditional SN procedure.

Example 2 is the method of example 1, wherein the SN is a candidate secondary node (C-SN), and wherein the processing includes: in response to determining (i) that the response includes the SN-to-MN container, and (ii) that the SN procedure is the conditional SN procedure, ignoring at least a portion of the SN-to-MN container.

Example 3 is the method of example 2, wherein the ignoring includes: ignoring an entirety of the SN-to-MN container.

Example 4 is the method of example 2, wherein the ignoring includes: ignoring a configuration included in the SN-to-MN container, the configuration for the UE to connect to the C-SN.

Example 5 is the method of example 1, wherein the SN is a candidate secondary node (C-SN), and wherein the processing includes: in response to determining (i) that the response includes the SN-to-MN container, and (ii) that the SN procedure is the conditional SN procedure, retrieving, from the SN-to-MN container, only one conditional configuration having a condition to be satisfied for the UE to connect to a candidate cell of the C-SN.

Example 6 is the method of example 1, wherein the SN is a candidate secondary node (C-SN), and wherein the processing includes: in response to determining (i) that the response does not include the SN-to-MN container, and (ii) that the SN procedure is the conditional SN procedure, processing the response without transmitting an error message responsive to exclusion of the SN-to-MN container.

Example 7 is the method of example 5 or 6, wherein the processing includes: retrieving, by the processing hardware, from a second container included in the response, one or more conditional configurations for a respective one or more candidate cells of the C-SN, each conditional configuration having a condition to be satisfied for the UE to connect to the candidate cell.

Example 8 is the method of example 7, wherein the retrieving includes: retrieving the one or more conditional configurations from the second container, the second container included in a Conditional PSCell Addition Information Acknowledge information element (IE).

Example 9 is the method of example 7 or 8, wherein the retrieving includes: retrieving the one or more conditional configurations from the second container, the second container formatted in accordance with a protocol for controlling radio resources.

Example 10 is the method of example 1, wherein processing the response includes: in response to determining (i) that the response includes the SN-to-MN container, and (ii) that the SN procedure is not the conditional SN procedure: retrieving, from the SN-to-MN container, a message formatted in accordance with a protocol for controlling radio resources; and transmitting the message to the UE.

Example 11 is the method of example 1, wherein processing the response includes: in response to determining (i) that the response does not include the SN-to-MN container, and (ii) that the SN procedure is not the conditional SN procedure, transmitting an error message to the SN responsive to exclusion of the SN-to-MN container.

Example 12 is the method implemented in a candidate secondary node (C-SN) for managing a conditional procedure that involves a user equipment (UE), a master node (MN), and the C-SN, the method including: receiving, by processing hardware of the C-SN from the MN, a request to perform a conditional secondary node (SN) procedure for the UE; generating, by the processing hardware, a response to the request, the generating including: excluding, from the response, an SN-to-MN container for conveying configuration information for communicating with an SN; including, in the response, the SN-to-MN container including only one conditional configuration for the C-SN; or including, in the response, the SN-to-MN container omitting any conditional configurations for the C-SN; and transmitting, by the processing hardware to the MN, the response.

Example 13 is the method of example 12, wherein the generating the response includes: generating one or more conditional configurations for a respective one or more candidate cells of the C-SN, each conditional configuration having a condition to be satisfied for the UE to connect to the candidate cell; including a single conditional configuration of the one or more conditional configurations in the SN-to-MN container; including, in the response, the SN-to-MN container including the single conditional configuration; and including remaining conditional configurations of the one or more conditional configurations, excluding the single conditional configuration, in a second container in the response, the second container different from the SN-to-MN container.

Example 14 is the method of example 12, wherein the generating the response includes: generating one or more conditional configurations for a respective one or more candidate cells of the C-SN, each conditional configuration having a condition to be satisfied for the UE to connect to the candidate cell; and including the one or more conditional configurations in a second container in the response, the second container different from the SN-to-MN container.

Example 15 is the method of example 14, wherein the generating includes: excluding, from the response, an SN-to-MN container for conveying configuration information for communicating with an SN.

Example 16 is the method of example 14, wherein the generating includes: including, in the response, the SN-to-MN container omitting any conditional configurations for the C-SN.

Example 17 is the method of any one of examples 13-16, wherein the transmitting includes: transmitting the response including the second container in a Conditional PSCell Addition Information Acknowledge information element (IE).

Example 18 is the method of any one of examples 13-17, wherein the transmitting includes: transmitting the response including the second container, the second container formatted in accordance with a protocol for controlling radio resources.

Example 19 is a method implemented in a master node (MN) for managing a conditional procedure that involves a user equipment (UE), a candidate secondary node (C-SN), and the MN. The method includes: (1) transmitting, by processing hardware of the MN to the C-SN, a request to perform a conditional secondary node (SN) procedure for the UE; (2) receiving, by the processing hardware from the C-SN, a response to the request; and (3) retrieving, by the processing hardware, a conditional configuration for the C-SN from an SN-to-MN container included in the response, the SN-to-MN container defined for conveying non-conditional configuration information for communicating with an SN.

Example 20 is the method of example 19, wherein retrieving the conditional configuration includes: retrieving the conditional configuration from a CG-Config information element (IE) included in the SN-to-MN container.

Example 21 is the method of example 19, wherein retrieving the conditional configuration includes: retrieving one or more conditional configurations for the C-SN from the response, the one or more conditional configurations including the conditional configuration.

Example 22 is the method of example 21, wherein retrieving the one or more conditional configurations includes: retrieving the one or more conditional configurations from a respective one or more CG-Config information elements (IEs) included in the response.

Example 23 is the method of any one of examples 19-22, wherein receiving the response: receiving an SN Addition Request Acknowledge message.

Example 24 is the method of any one of examples 19-23, wherein retrieving the conditional configuration includes: retrieving the conditional configuration from an S-NG-RAN node to M-NG-RAN node Container.

Example 25 is the method of any one of examples 19-23, wherein retrieving the conditional configuration includes: retrieving the conditional configuration from an SgNB to MeNB Container.

Example 26 is the method of any one of examples 19-25, wherein the conditional SN procedure is a conditional primary secondary cell (PSCell) addition or change (CPAC) procedure.

Example 27 is the method of any one of examples 19-25, wherein the conditional SN procedure is a conditional SN addition or change (CSAC) procedure.

Example 28 is the method of any one of examples 19-27, further including: transmitting, by the processing hardware, the conditional configuration to the UE.

Example 29 is a method implemented in a candidate secondary node (C-SN) for managing a conditional procedure that involves a user equipment (UE), a master node (MN), and the C-SN. The method includes: (1) receiving, by processing hardware of the C-SN from the MN, a request to perform a conditional secondary node (SN) procedure for the UE; (2) generating, by the processing hardware, a response to the request, the response including an SN-to-MN container including a conditional configuration for the C-SN, the SN-to-MN container defined for conveying non-conditional configuration information for communicating with an SN; and (3) transmitting, by the processing hardware to the MN, the response.

Example 30 is the method of example 29, wherein generating the response includes: including the conditional configuration in a CG-Config information element (IE) in the SN-to-MN container.

Example 31 is the method of example 29, wherein generating the response includes: including one or more conditional configurations for the C-SN in the response.

Example 32 is the method of example 31, wherein including the one or more conditional configurations in the response includes: including the one or more conditional configurations in a respective one or more CG-Config information elements (IEs) in the response.

Example 33 is the method of any one of examples 29-32, wherein transmitting the response includes: transmitting an SN Addition Request Acknowledge message.

Example 34 is the method of any one of examples 29-33, wherein generating the response includes: including the conditional configuration in an S-NG-RAN node to M-NG-RAN node Container in the response.

Example 35 is the method of any one of examples 29-33, wherein generating the response includes: including the conditional configuration in an SgNB to MeNB Container in the response.

Example 36 is the method of any one of examples 29-35, wherein the conditional SN procedure is a conditional primary secondary cell (PSCell) addition or change (CPAC) procedure.

Example 37 is the method of any one of examples 29-35, wherein the conditional SN procedure is a conditional SN addition or change (CSAC) procedure.

Example 38 is a network node including processing hardware and configured to implement a method according to any one of the preceding examples.

The following description may be applied to the description above.

A user device in which the above-described methods can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the methods can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method implemented in a master node (MN) for managing a conditional procedure that involves a user equipment (UE), a candidate secondary node (C-SN), and the MN, the method comprising:
transmitting, by the MN to the C-SN, a request to perform the conditional procedure related to the C-SN and the UE, the conditional procedure associated with a condition and a conditional configuration according to which the UE connects to the C-SN when the condition is satisfied;
receiving, by the MN from the C-SN, a response to the request, the response including an SN-to-MN container; and
retrieving, by the MN, the conditional configuration from the SN-to-MN container.

2. The method of claim 1, wherein retrieving the conditional configuration includes:
retrieving the conditional configuration from a CG-Config information element (IE) included in the SN-to-MN container.

3. The method of claim 1, wherein retrieving the conditional configuration includes:
retrieving, from the response, one or more conditional configurations, the conditional configuration included in the one or more conditional configurations, wherein the UE connects to the C-SN in accordance with a particular conditional configuration of the one or more conditional configurations when a respective condition of one or more conditions is satisfied.

4. The method of claim 3, wherein retrieving the one or more conditional configurations includes:
retrieving the one or more conditional configurations from a respective one or more CG-Config information elements (IEs) included in the response.

5. The method of any one of the preceding claims, wherein receiving the response:
receiving an SN Addition Request Acknowledge message.

6. The method of any one of the preceding claims, wherein retrieving the conditional configuration includes:
retrieving the conditional configuration from an S-NG-RAN node to M-NG-RAN node Container or an SgNB to MeNB Container.

7. The method of any one of the preceding claims, wherein the conditional procedure is a conditional primary secondary cell (PSCell) addition or change (CPAC) procedure or a conditional SN addition or change (CSAC) procedure.

8. A method implemented in a candidate secondary node (C-SN) for managing a conditional procedure that involves a user equipment (UE), a master node (MN), and the C-SN, the method comprising:
receiving, by the C-SN from the MN, a request to perform the conditional procedure related to the C-SN and the UE, the conditional procedure associated with a condition and a conditional configuration according to which the UE connects to the C-SN when the condition is satisfied;
generating, by the C-SN, a response to the request, the response including an SN-to-MN container including the conditional configuration; and
transmitting, by the C-SN to the MN, the response.

9. The method of claim 8, wherein generating the response includes:
including the conditional configuration in a CG-Config information element (IE) in the SN-to-MN container.

10. The method of claim 8, wherein generating the response includes:
including, in the response, one or more conditional configurations, the conditional configuration included in the one or more conditional configurations, wherein the UE connects to the C-SN in accordance with a particular conditional configuration of the one or more conditional configurations when a respective condition of one or more conditions is satisfied.

11. The method of claim 10, wherein including the one or more conditional configurations in the response includes:
including the one or more conditional configurations in a respective one or more CG-Config information elements (IEs) in the response.

12. The method of any one of claims 8-11, wherein transmitting the response includes:
transmitting an SN Addition Request Acknowledge message.

13. The method of any one of claims 8-12, wherein generating the response includes:
including the conditional configuration in an S-NG-RAN node to M-NG-RAN node Container or an SgNB to MeNB Container in the response.

14. The method of any one of claims 8-13, wherein the conditional procedure is a conditional primary secondary cell (PSCell) addition or change (CPAC) procedure or a conditional SN addition or change (CSAC) procedure.

15. A method implemented in a master node (MN) for managing a conditional procedure configuration related to a user equipment (UE) able to communicate in dual connectivity (DC) with the MN and a secondary node (SN), the method comprising:
transmitting, by the MN to the SN, a request to perform a procedure related to communication between the UE and the SN;
receiving, by the MN from the SN, a response to the request, the response including an SN-to-MN container; and
determining, by the MN, whether the procedure is a conditional procedure based on a content of the SN-to-MN container.

16. The method of claim 15, wherein if the SN-to-MN container is empty, then a result of the determining is that the procedure is conditional and the MN retrieves the conditional procedure configuration from another container or another message.

17. The method of claim 15, wherein if the SN-to-MN container includes more than one SN-UE-communication configurations, then a result of the determining is that the procedure is conditional and the conditional procedure configuration is among the more than one SN-UE-communication configurations.

18. A network node comprising processing hardware and a transceiver, configured to implement a method according to any one of the preceding claims.
